(19) United States
(12) Patent Application Publication
(10) Pub. No.: US 2017/0300846 A1
(43) Pub. Date: Oct. 19, 2017

(54) METHOD AND APPARATUS FOR DELEGATING TASKS TO TECHNICIANS, UTILIZING A BACK-END AND MOBILE SERVICEABILITY APPLICATION

(71) Applicant: Decisive Communications, Inc., Ijamsville, MD (US)

(72) Inventor: Timithy B. Harwood, ljamsville, MD (US)

(21) Appl. No.: 15/457,950

(22) Filed: Mar. 13, 2017

Related U.S. Application Data
(60) Provisional application No. 62/308,366, filed on Mar. 15, 2016.

(51) Int. Cl. G06Q 10/06; G06Q 30/00; G06Q 10/10; G06F 3/147; G06F 17/24

(52) U.S. Cl. CPC G06Q 10/063112; G06Q 30/016; G06Q 10/063114; G06F 3/147; G06F 17/245; G06Q 10/1097

(57) ABSTRACT

A method and an apparatus for delegating tasks to cable line installation technicians comprises a memory unit to store a database comprising one or more records associated with at least one technician, and a set of program modules. A processor executes the set of program modules, and the set of program modules comprises an input module, a task delegation module, and a display module. The input module, receives from at least one customer, a first input. The task delegation module, transmits a request to perform the at least one task, to at least one technician, assign the at least one technician with permission levels required by the at least one technician to perform the at least one task, request the at least one technician to perform the at least one task. The display module presents the at least one technician with information associated with the at least one task.

### CROSS REFERENCE TO APPLICATION

This patent application claims the benefit of U.S. Provisional Application, App. No. 62/308,366, filed on Mar. 15, 2016. The above application is incorporated by reference herein in its entirety.

### FIELD OF THE INVENTION

The present invention relates to a method and apparatus for determining cable communication line service requirements utilizing a back-end, and mobile serviceability application of an apparatus for delegating tasks, and, more particularly, to a method and apparatus that allows for quick and secure access to and determination of needed cable line servicing requirements for homes/businesses from either/both a back-end terminal and/or a mobile device for cable company service technicians and/or employees.

### BACKGROUND OF THE INVENTION

Mobile applications have pervaded every aspect of life in the twenty first century. Examples of the on-demand mobile applications include but are not limited to Repair Pal, Uber, and Showaround. Today, users access the on-demand mobile applications for multiple purposes. As often is the case, users access the mobile applications to acquire information about nearby restaurants, lodges, electronics showrooms, and car repair centers. Further, the users access the mobile applications to connect with service providers having expertise in a plurality of fields. Potentially, mobile applications have a wide gamut of practical applications. For example, the mobile applications have potential to assist service providers and customers in delegating tasks to technicians dabbling in labor and time intensive tasks such as installation of television and telephone cables in a locality. Presently, service providers delegate cable installation tasks cable line installation technicians manually. Today, manual delegation of tasks to the technicians is resulting in extensive losses in time and money for the service providers.

Therefore, there is a need in the art for apparatus for delegating tasks and a computer implemented method of delegating tasks to a cable installation technician.

### SUMMARY OF THE INVENTION

The present invention relates to a method and an apparatus of delegating tasks to cable installation technicians.

In one embodiment of the present invention, an apparatus for delegating tasks delegating tasks to cable line installation technicians comprises a memory unit to store a database comprising one or more records associated with at least one technician, and a set of program modules. The one or more records comprise information regarding a plurality of tasks delegated to at least one technician, locations associated with each of the plurality of tasks, priority levels of each of the plurality of tasks, and permission levels associated with the at least one technician. A processor executes the set of program modules. The set of program modules comprises an input module, a task delegation module, and a display module. The input module, receives from at least one customer, a first input. The first input comprises a request to perform at least one task, a location associated with the at least one task, a deadline associated with the at least one task, and information regarding permission levels required by the at least one technician to perform the at least one task. The task delegation module, transmits the request to perform the at least one task, the deadline associated with the at least one task, and the location associated with the at least one task, to at least one technician, assign the at least one technician with permission levels required by the at least one technician to perform the at least one task, request the at least one technician to perform the at least one task, and receive a confirmation message from the at least one technician, to perform the at least one task. The display module presents the at least one technician with information associated with the at least one task and the plurality of tasks.

In one embodiment of the present invention, the input module receives the request via at least one of a computer mouse, a touch screen, a microphone, and a camera. The display module presents information to the at least one technician via at least one of a Liquid Crystal Display screen (LCD), an LED screen, a speaker, a smartphone, a laptop, a personal computer, and a personal digital assistant. The at least one technician and the at least one customer communicates with the apparatus for delegating tasks via at least one user terminal device. The user terminal device is at least one of a personal computer, a laptop, a smartphone, and a personal digital assistant. The one or more records further comprises delegation date of each of the plurality of tasks, deadlines assigned for each of the plurality of tasks, and priority levels associated with the plurality of tasks. The display module presents the information in a tabulated format. The display module sorts the at least one task and the plurality of tasks based on at least one of delegation date of each of the plurality of tasks, deadlines assigned for each of the plurality of tasks, and priority levels associated with the plurality of tasks.

In one embodiment of the present invention, a computer implemented method of delegating tasks to cable line installation technicians comprises storing in a memory unit, a database comprising one or more records associated with at least one technician, and a set of program modules. The one or more records comprise information regarding a plurality of tasks delegated to at least one technician, locations associated with each of the plurality of tasks, priority levels of each of the plurality of tasks, and permission levels associated with the at least one technician. Further method comprises receiving by a processor via an input module, a first input, wherein the first input comprises a request to perform at least one task, a location associated with the at least one task, a deadline associated with the at least one task, and information regarding permission levels required by the at least one technician to perform the at least one task. Further method comprises transmitting by the processor, via a task delegation module, the request to perform the at least one task, the deadline associated with the at least one task, and the location associated with the at least one task, to the at least one technician. Further method comprises assigning by the processor, via the task delegation module the at least one technician with permission levels required by the at least one technician to perform the at least one task. Further method comprises requesting by the processor, via the task delegation module, the at least one technician to perform the at least one task. Further method comprises receiving by the processor via the task delegation module, a confirmation message from the at least one technician, to perform the at least one task. Further method comprises presenting by the processor via a display module, the at least one technician with information associated with the at least one task and the plurality of tasks.

### BRIEF DESCRIPTION OF THE DRAWINGS

FIG. 1 is a block diagram of an environment implemented in accordance with various embodiments of the invention.

FIG. 2 exemplarily illustrates a screen shot of a log-in page for the back-end aspect of the apparatus for delegating tasks, in accordance with an embodiment of the present invention.

FIG. 3 exemplarily illustrates a home screen in accordance with one embodiment of the present invention.

FIG. 4 exemplarily illustrates a screenshot of a pie chart based representation of data associated with the “average days aging feature”, in accordance with one embodiment of the present invention.

FIG. 5 exemplarily illustrates a screen shot of a home screen comprising graphical representation of an option for a user to access the ticket metrics feature, in accordance with one embodiment of the present invention.

FIG. 6 exemplarily illustrates a screenshot of graphical representation of the plurality of gauges forming part of the ticket metrics feature, in accordance with one embodiment of the present invention.

FIG. 7 exemplarily illustrates a screen shot of a home screen comprising graphical representation of an option for a user to access the ticket metrics feature, in accordance with one embodiment of the present invention.

FIG. 8 exemplarily illustrates a screenshot of a plurality of reports displayed by a task delegation module, in accordance with one embodiment of the present invention.

FIG. 9 exemplarily illustrates a portion of a screenshot of a technician performance report, in accordance with one embodiment of the present invention.

FIG. 10 exemplarily illustrates a portion of a screenshot of an area performance report, in accordance with one embodiment of the present invention.

FIG. 11 exemplarily illustrates a portion of a screenshot of a company performance report, in accordance with one embodiment of the present invention.

FIG. 12 exemplarily illustrates a portion of a screenshot of a company performance report for a user-specified date range, in accordance with one embodiment of the present invention.

FIG. 13 exemplarily illustrates a portion of a screenshot of a technician or tech performance report for a time interval up to three days, in accordance with one embodiment of the present invention.

FIG. 14 exemplarily illustrates a portion of a screenshot of a tech performance report for a time interval between four to seven days, in accordance with one embodiment of the present invention.

FIG. 15 exemplarily illustrates a screenshot of a home screen comprising a “search feature”, in accordance with one embodiment of the present invention.

FIG. 16 exemplarily illustrates a screenshot of a “search feature”, in accordance with one embodiment of the present invention.

FIG. 17 illustrates a screen shot of a page of a completed search for the back-end aspect of the apparatus for delegating tasks, in accordance with an embodiment of the present invention.

FIG. 18 exemplarily illustrates a screen shot of another page of a completed search for the back-end aspect of the apparatus for delegating tasks, in accordance with another embodiment of the present invention.

FIG. 19 exemplarily illustrates a screenshot of a home screen comprising an option to enter a new survey, in accordance with one embodiment of the present invention.

FIG. 20 exemplarily illustrates a screen shot of a page comprising details associated with a new survey for the back-end aspect of the apparatus for delegating tasks, in accordance with another embodiment of the present invention.

FIG. 21 exemplarily illustrates a menu screen of a mobile application running in a user terminal, in accordance with an embodiment of the present invention.

FIG. 22 exemplarily illustrates a home screen of a mobile application running in a user terminal, in accordance with an embodiment of the present invention.

FIG. 23 is an exemplary screenshot of a pictorial map comprising information regarding the plurality of tasks, in accordance with one embodiment of the present invention.

FIG. 24 is an exemplary screenshot of a list comprising information regarding the plurality of tasks sorted by priority level of each of the plurality of tasks, in accordance with one embodiment of the present invention.

FIG. 25 is an exemplary screenshot of another pictorial map comprising information regarding the plurality of tasks, in accordance with one embodiment of the present invention.

FIG. 26 exemplarily illustrates a first page of a survey form comprising fields for entering electronic record information and customer address information in accordance with an embodiment of the present invention.

FIG. 27 illustrates a screen shot of a second page of the survey form, according to an embodiment of the present invention.

FIG. 28 exemplarily illustrates a third page of a survey form comprising fields enabling technicians to confirm information provided by the technician in address information and electronic record information fields, in accordance with one embodiment of the present invention.

FIG. 29 exemplarily illustrates a fourth page of a survey form comprising options for a technician to initiate at least one of a plant extension and a mobile drop, in accordance with one embodiment of the present invention.

FIG. 30 exemplarily illustrates a fifth page of a survey form comprising fields to enter readiness, drop type and road bore of one of a mobile drop and a plant extension, in accordance with one embodiment of the present invention.

FIG. 31 exemplarily illustrates a sixth page of a survey form instructing a technician to commence placing pins for a drop pin path, in accordance with one embodiment of the present invention.

FIG. 32 exemplarily illustrates a seventh page of a survey form instructing a technician to continue placing pins for a drop pin path, in accordance with one embodiment of the present invention.

FIG. 33 exemplarily illustrates an eight page of a survey form instructing a technician to continue placing pins for a drop pin path, in accordance with one embodiment of the present invention.

FIG. 34 exemplarily illustrates a ninth page of a survey form instructing a technician to take a picture, in accordance with one embodiment of the present invention.

FIG. 35 exemplarily illustrates a tenth page of a survey form enabling a technician to assign a picture to a drop pin, in accordance with one embodiment of the present invention.

FIG. 36 exemplarily illustrates an eleventh page of a survey form comprising a first view of a drop pin path, in accordance with one embodiment of the present invention.

FIG. 37 exemplarily illustrates a twelfth page of a survey form comprising a second view of a drop pin path, in accordance with one embodiment of the present invention.

FIG. 38 exemplarily illustrates a thirteenth page of a survey form enabling a technician to delete a pin in a drop pin path, in accordance with one embodiment of the present invention.

FIG. 39 exemplarily illustrates a fourteenth page of a survey form enabling a technician to choose a pin type in a drop pin path, in accordance with one embodiment of the present invention.

FIG. 40 exemplarily illustrates a fifteenth page of a survey form enabling a technician to assign another picture to a drop pin in a drop pin path, in accordance with one embodiment of the present invention.

FIG. 41 exemplarily illustrates a sixteenth page of a survey form enabling a technician to calculate footage of a drop pin path, in accordance with one embodiment of the present invention.

FIG. 42 exemplarily illustrates a seventeenth page of a survey form comprising fields for entering information regarding passing of cables, requirement of permits, and number of permits required in a plant extension drop pin path, in accordance with one embodiment of the present invention.

FIG. 43 exemplarily illustrates an eighteenth page of a survey form instructing a technician to commence placing plant extension pins, in accordance with one embodiment of the present invention.

FIG. 44 exemplarily illustrates a nineteenth page of a survey form enabling a technician to place plant extension pins in a drop pin path, in accordance with one embodiment of the present invention.

FIG. 45 exemplarily illustrates a twentieth page of a survey form enabling technician to place another plant extensions, in accordance with one embodiment of the present invention.

FIG. 46 exemplarily illustrates a twenty first page of a survey form enabling technician to designate a cable installation as one of an aerial cable installation and an underground cable installation, in accordance with one embodiment of the present invention.

FIG. 47 exemplarily illustrates a twenty second page of a survey form enabling a technician to designate a pin as one of a pole, a riser pole, a pedestal, a tie down, a bend, a midpoint, and an active plant, in accordance with one embodiment of the present invention.

FIG. 48 exemplarily illustrates a twenty third page of a survey form comprising drop pin path footage of plant extension pins, in accordance with one embodiment of the present invention.

FIG. 49 exemplarily illustrates a twenty fourth page of a survey form comprising another drop pin path footage of plant extension pins, in accordance with one embodiment of the present invention.

FIG. 50 exemplarily illustrates a twenty fifth page of a survey form enabling a technician and a surveyor to add manual notes into a plurality of comment fields, in accordance with one embodiment of the present invention.

FIG. 51 exemplarily illustrates a twenty sixth page of a survey form comprising a portion of a final summary presented to a technician, in accordance with one embodiment of the present invention.

FIG. 52 exemplarily illustrates a twenty seventh page of a survey form comprising a confirmation message to a technician, in accordance with one embodiment of the present invention.

FIG. 53 is a flowchart of a method of delegating tasks to cable installation technicians, in accordance with an embodiment of the present invention.

### DETAILED DESCRIPTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

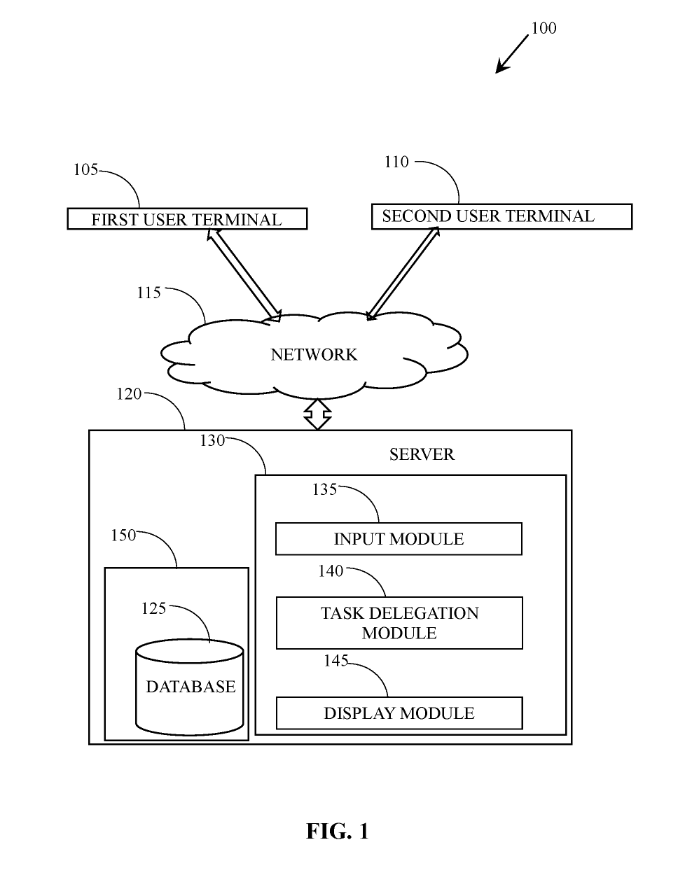

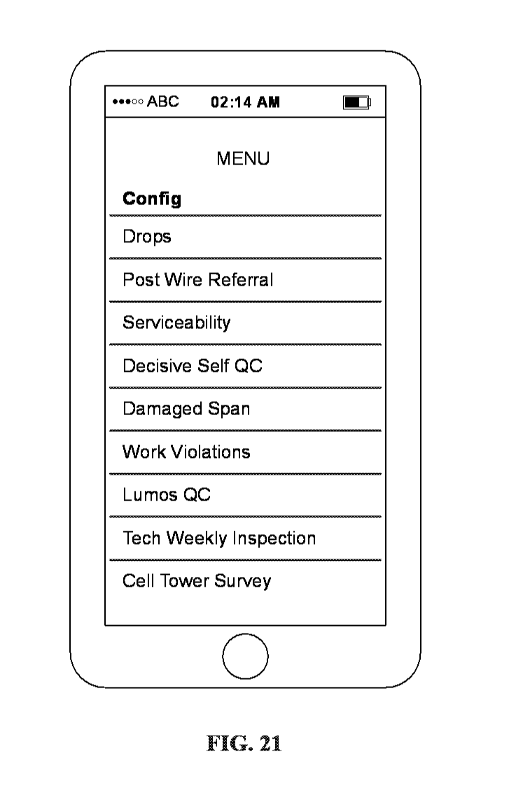

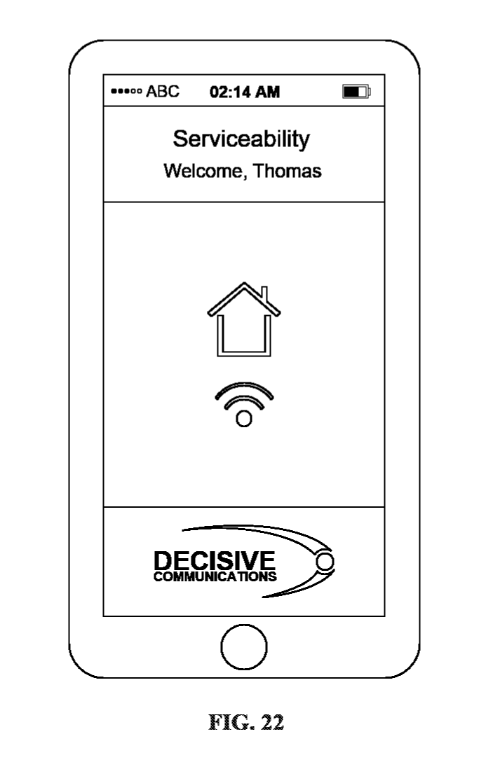

FIG. 1 is a block diagram of an environment 100 in accordance with which various embodiments of the present invention are implemented. The environment 100 comprises a first user terminal 105, a second user terminal 110 and a server 120. The first user terminal 105, the second user terminal 110, and the server 120 are connected with each other via a network 115. The network 115 is at least one of a Local Area Network, a wide area network, and a mobile network. The environment 100 hosts an apparatus for delegating tasks comprising a memory unit 150, and a processor 130. At least one technician and at least one customer communicates with the apparatus for delegating tasks via at least one of the first user terminal 105 and the second user terminal 110. The first user terminal 105 and the second user terminal 110 are at least one of personal computers, laptops, smartphones, and personal digital assistants. In one example, a first portion of the apparatus for delegating tasks is implemented as a mobile application running on the first user terminal 105 and the second user terminal 110. FIG. 21 exemplarily illustrates a menu screen of a mobile application running in a user terminal, in accordance with an embodiment of the present invention. Moreover, FIG. 22 exemplarily illustrates a home screen of a mobile application running in a user terminal, in accordance with an embodiment of the present invention.

Referring FIG. 1 again, the apparatus for delegating tasks requests the technician as well as the customer to sign in into the apparatus for delegating tasks using one or more user credentials. Examples of the user credentials include, but are not limited to usernames, passwords, fingerprints, and retina scans.

The memory unit 150 stores a database 125 comprising one or more records associated with at least one technician, and a set of program modules. The one or more records comprise information regarding a plurality of tasks delegated to at least one technician, locations associated with each of the plurality of tasks, priority levels of each of the plurality of tasks, and permission levels associated with the at least one technician. The permission levels indicate a set of mobile applications and features accessible to the at least one technician. The permission levels are managed in the database 125 by a local administrator. The permission levels are capable of being altered dynamically for each technician among a plurality of technicians as needed. After determination of the permission levels by the local administrator, a plurality of applications and features of the apparatus are rendered inaccessible to the technician.

The one or more records further comprises delegation date of each of the plurality of tasks, deadlines assigned for each of the plurality of tasks, and priority levels associated with the plurality of tasks. The processor 130 executes the set of program modules. The set of program modules comprises an input module 135, a task delegation module 140, and a display module 145. The input module 135, receives from at least one customer, a first input. The first input comprises a request to perform at least one task, a location associated with the at least one task, a deadline associated with the at least one task, and information regarding permission levels required by the at least one technician to perform the at least one task. The input module 135 receives the first input via at least one of a computer mouse, a touch screen, a microphone, and a camera.

The task delegation module 140, transmits the request to perform the at least one task, the deadline associated with the at least one task, and the location associated with the at least one task, to at least one technician, assign the at least one technician with permission levels required by the at least one technician to perform the at least one task, request the at least one technician to perform the at least one task, and receive a confirmation message from the at least one technician, to perform the at least one task. In one example, the task delegation module 140 receives the confirmation message via the technician's entries in a survey form.

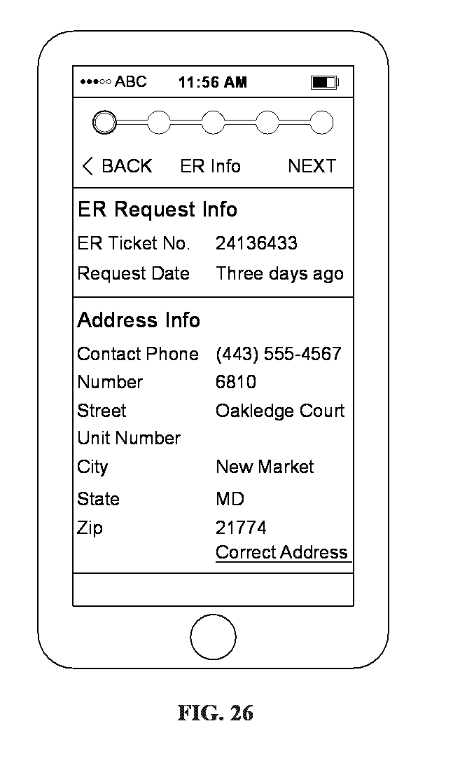

The task delegation module 140 presents the survey form to the technician and enables the technician to a plurality of fields in the survey form. In one example, the plurality of fields comprises an electronic record (ER) information field, and a customer address information field. Referring to FIG. 26, exemplarily illustrates a first page of a survey form comprising fields for entering electronic record information and customer address information in accordance with an embodiment of the present invention. In one example, parts of the survey form are automatically filled by a task delegation module (not shown) from information received from a plurality of previous tickets and survey forms.

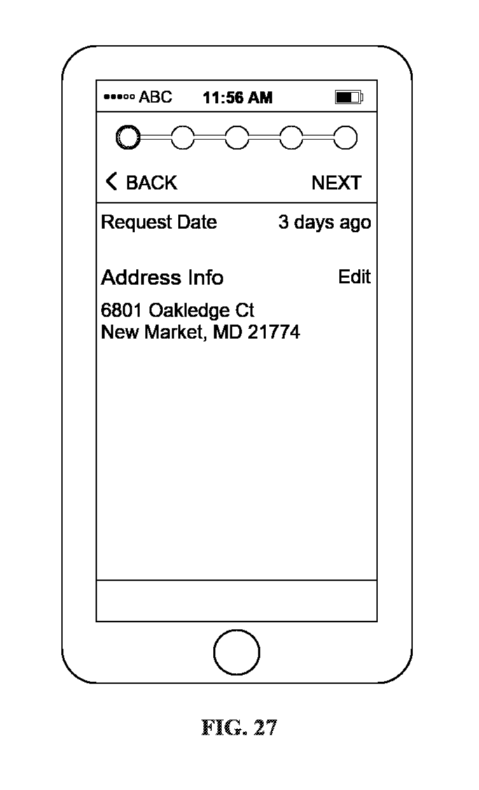

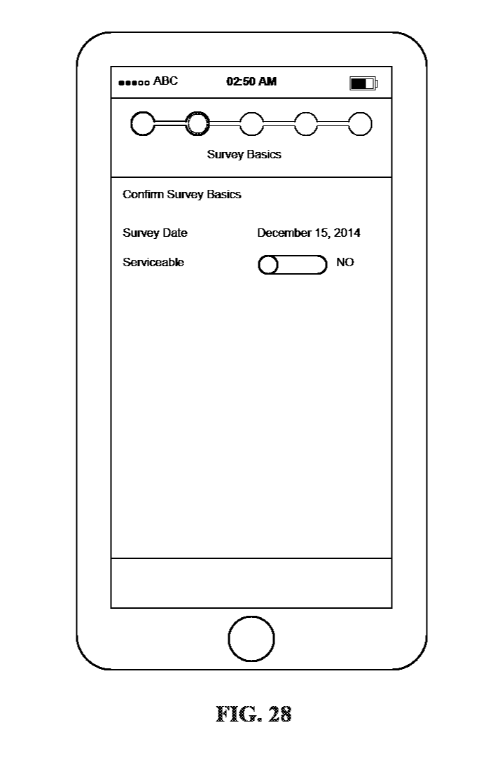

Referring FIG. 1 again, the task delegation module 140 enables the technician to edit the address information. In one example, the technician is provided with an opportunity to edit customer address information by activating a first graphical button named “correct address button”. Once the technician corrects address, the task delegation module 140 changes pricing information from a standard survey fee to a corrected address fee. FIG. 27 exemplarily illustrates a second page of a survey form comprising fields for editing customer address information, in accordance with one embodiment of the present invention. FIG. 28 exemplarily illustrates a third page of a survey form comprising fields enabling technicians to confirm information provided by the technician in address information and electronic record information fields is correct, in accordance with one embodiment of the present invention. The technician is enabled to confirm electronic record information, address information, and a survey date.

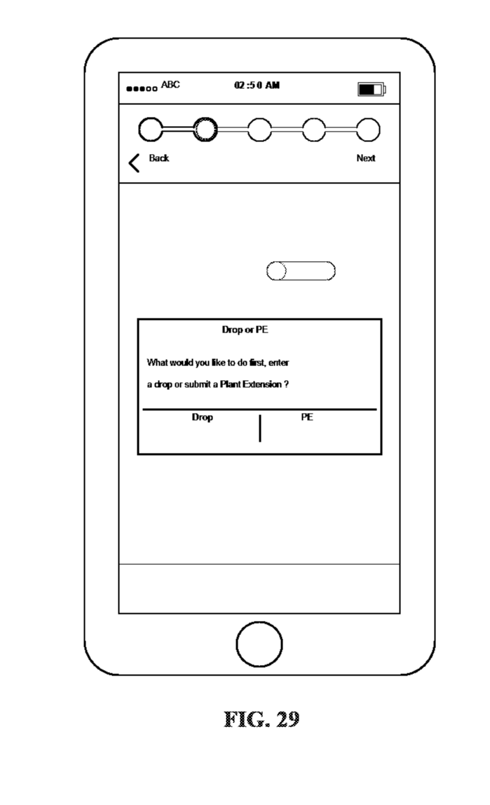

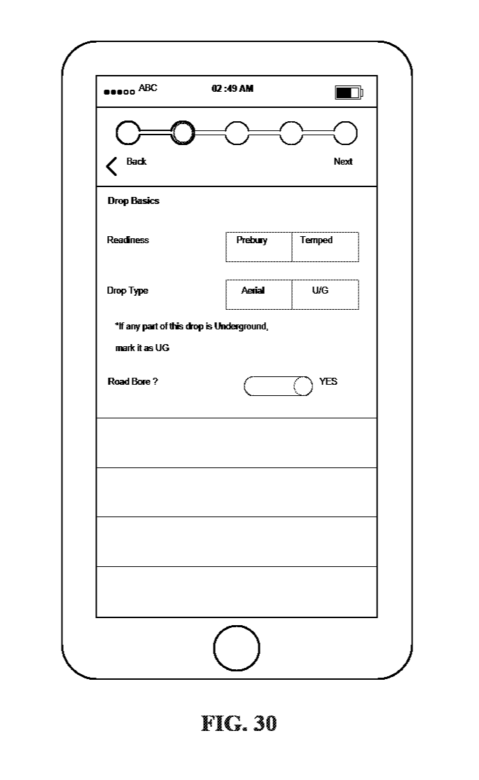

Referring FIG. 1 again, the survey form comprises a status bar comprising an indication of the technician's progress in completing the survey form. Further, the status bar comprises navigation buttons to enable the technician to navigate between different pages of the survey form. In one example, the task delegation module 140 receives an estimation of the drop footage via the survey form. The survey form enables the technician to input the estimate of drop footage of a cable installation in the survey form. The task delegation module 140 limits the technician from installing cable with a drop footage greater than 250 feet. In one example, if the technician inputs drop footage greater than 250 feet, the task delegation module 140 presents the technician with the message “path too long”. In one example, if the technician refuses to perform the at least one task, then the technician is enabled to add a plant extension and the task delegation module 140 reduces the drop footage and logic for the drop footage to a value lesser than 150 feet. FIG. 29 exemplarily illustrates a fourth page of a survey form comprising options for a technician to initiate at least one of a plant extension and a mobile drop, in accordance with one embodiment of the present invention. FIG. 30 exemplarily illustrates a fifth page of a survey form comprising fields to enter readiness, drop type and road bore of one of a mobile drop and a plant extension, in accordance with one embodiment of the present invention. Data pertaining to readiness, drop type and road bore comprise drop basics. If the technician chooses the drop type as underground, then the mobile drop and the plant extension is considered as underground in a final summary. Data pertaining to “readiness” indicates if the underground is pre-buried or if there is a temporary on ground. Data pertaining to “road bore” determines necessity of underground boring equipment.

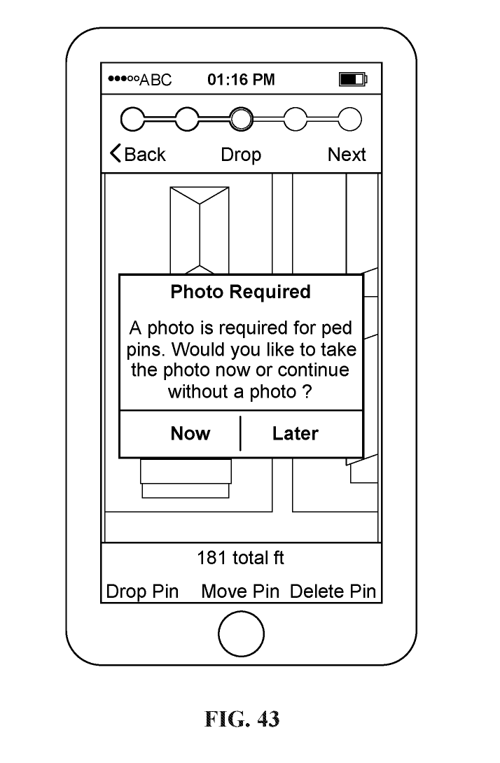

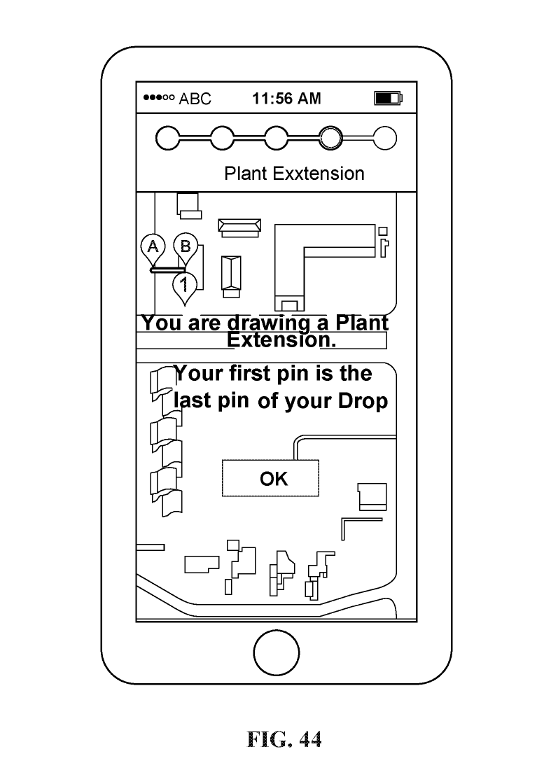

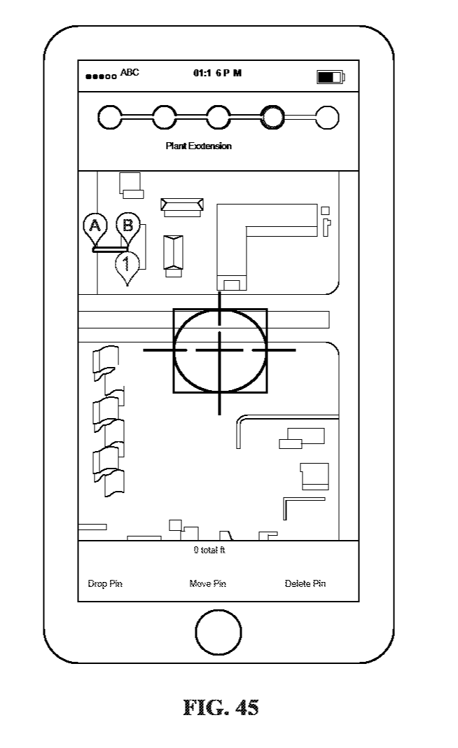

In one example, the plant extension is represented by plant extension pins on a map. Unlike other pins, the plant extension pins may be of an unlimited number. FIG. 43 exemplarily illustrates an eighteenth page of a survey form instructing a technician to commence placing plant extension pins, in accordance with one embodiment of the present invention. FIG. 44 exemplarily illustrates a nineteenth page of a survey form enabling a technician to place plant extension pins in a drop pin path, in accordance with one embodiment of the present invention. FIG. 45 exemplarily illustrates a twentieth page of a survey form enabling technician to place another plant extensions, in accordance with one embodiment of the present invention.

Referring FIG. 1 again, if the technician starts at one of the pedestal pin and the pole pin, then the task delegation module 140 requires the technician to take a picture of the pedestal to reduce redundancies. Location of the pedestal pin is identified by the task delegation module 140 as end of a drop pin path. The task delegation module 140 delegates the plant extension pins with an orange color. In another example, the task delegation module 140 receives a justification form the technician for refusing to perform the task. The task delegation module 140 enables the user to input technical aspects about the cable installation such as road bore, underground cable installation, and information associated with special equipments required for the cable installation. In another example, the task delegation module 140 instructs the technician to select a drop pin path for the cable installation.

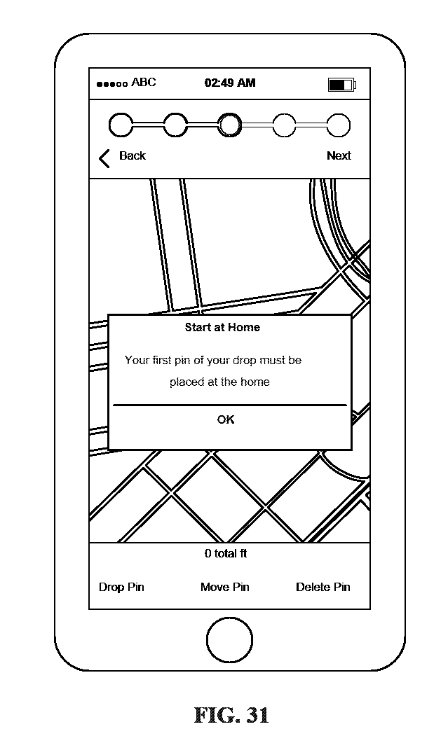

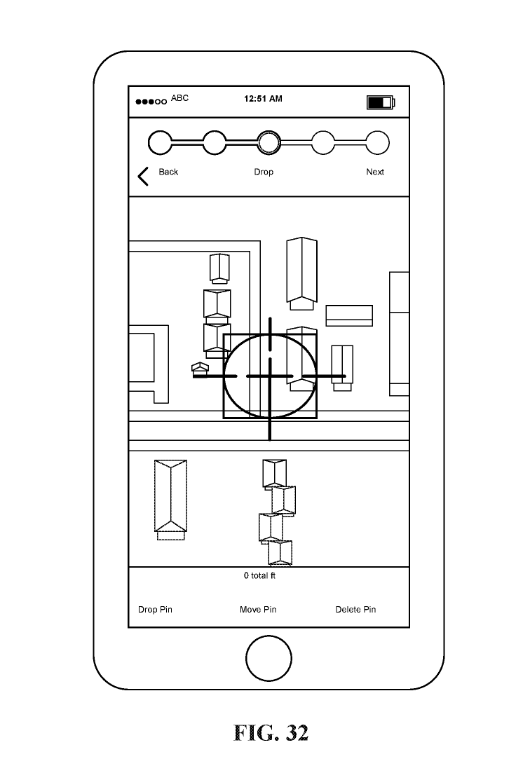

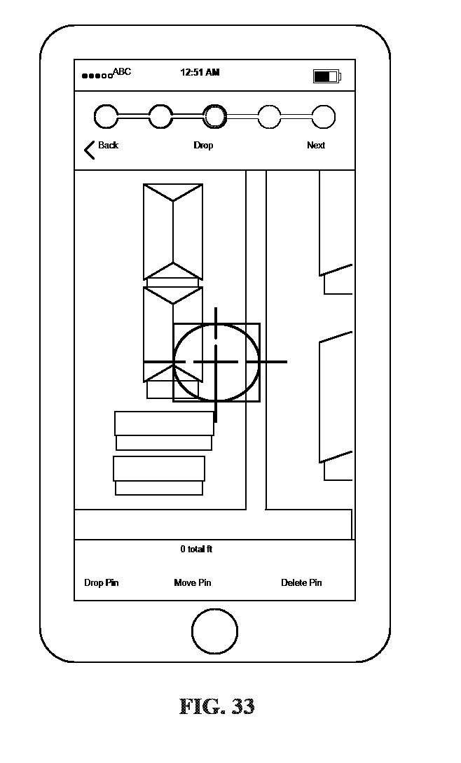

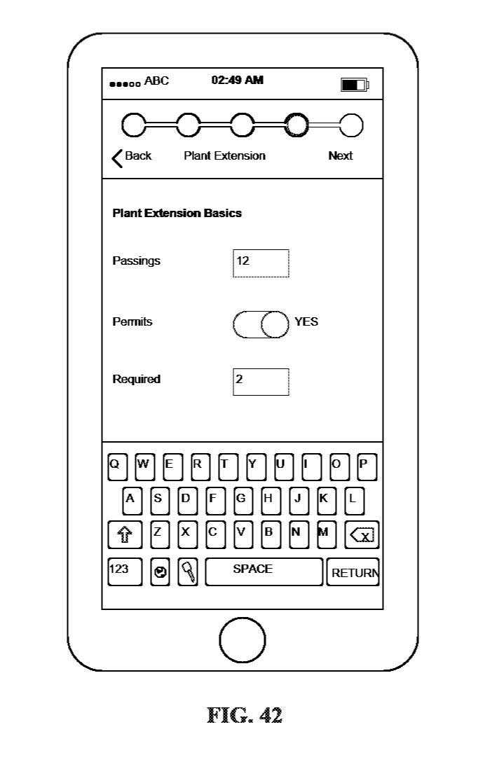

The task delegation module 140 directs the technician to start at a home entry point and then directs the technician to draw the drop pin path from the home entry point to a pedestal box. FIG. 42 exemplarily illustrates a seventeenth page of a survey form comprising fields for entering information regarding passing of cables, requirement of permits, and number of permits required in a plant extension drop pin path, in accordance with one embodiment of the present invention. A technician is enabled to enter number of active passing required in the plant extension. FIG. 31 exemplarily illustrates a sixth page of a survey form instructing a technician to commence placing pins for a drop pin path, in accordance with one embodiment of the present invention. The technician is enabled to begin the drop pin path from a pedestal location. If the technician chooses to start at the pedestal location, then a task delegation module (not shown) directs user to go to an active plant and away from home location. FIG. 32 exemplarily illustrates a seventh page of a survey form instructing a technician to continue placing pins for a drop pin path, in accordance with one embodiment of the present invention. FIG. 33 exemplarily illustrates an eight page of a survey form instructing a technician to continue placing pins for a drop pin path, in accordance with one embodiment of the present invention. A task delegation module (not shown) notifies the technician of direction of drop pin locations on a pictorial map. The technician is enabled to view entire path from an active plant to a pedestal pin on the pictorial map. The technicians are enabled to add and remove drop pins until a survey is complete. If the technician begins placing pins at pedestal pin, then a drop pin path is completed when the drop pin path reaches an active plant. If the technician begins placing pins at the active plant, then a drop pin path is completed when the drop pin path reaches a pedestal pin. The technician takes pictures of the pedestal pin and the active plant to reduces redundancy.

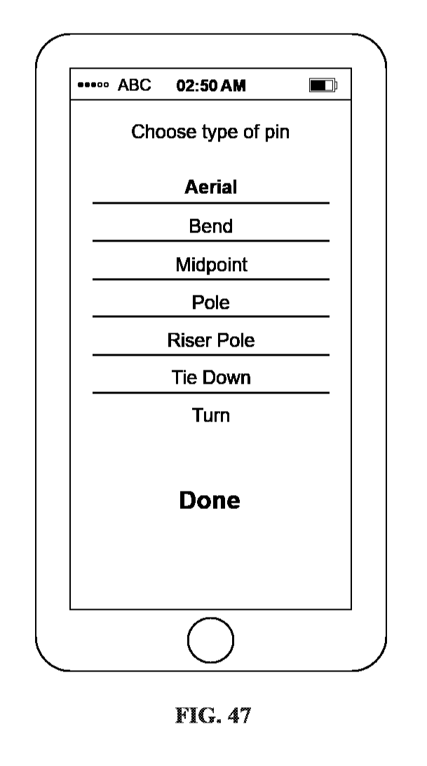

Referring to FIG. 1 again, the task delegation module 140 has a predefined logical sequence, which identifies each pin with an icon of a house for the home pin, pedestal for the pedestal pin, and various pin bubbles for path mid-points. In a preferred embodiment, the technician will have a minimum requirement of 3 pins and a maximum requirement of 4 pins. The task delegation module 140 presents position of a plurality of pins in the drop pin path on a map for ease of use of the technician. The plurality of pins comprises a pole, a riser pole, a pedestal, a tie down, a bend, a midpoint, and an active plant. FIG. 47 exemplarily illustrates a twenty second page of a survey form enabling a technician to designate a pin as one of a pole, a riser pole, a pedestal, a tie down, a bend, a midpoint, and an active plant, in accordance with one embodiment of the present invention.

Referring to FIG. 1 again, the pole is an aerial marker where the active plant and an aerial drop meets. The riser pole signifies a directional change from aerial to underground or from underground to aerial. The task delegation module 140 requires a photo to set up a pedestal pin. The pedestal pin is the shared location where the underground cable meets the plant extension. The bend indicates directional change in an original drop pin path. The active plant requires a photo.

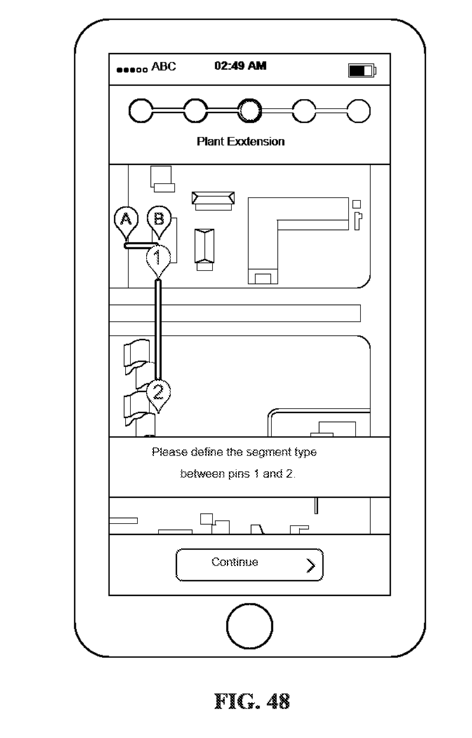

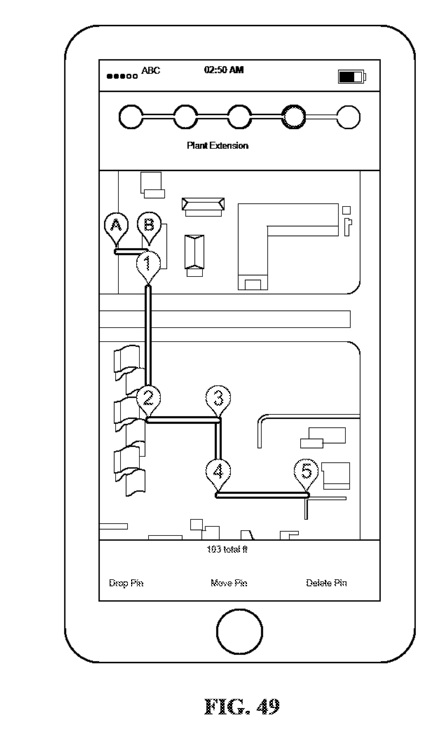

Further, the apparatus for delegating tasks calculates drop footage between the pins. In a preferred embodiment, if the footage entered reaches a 300 feet maximum threshold, and the drop pin path is rejected by the task delegation module 140. The task delegation module 140 displays a rejection message, such as “Upload Failed—Error—Path Length exceeds Maximum Threshold”. Further, the technician is prompted to confirm locations of the plurality of pins and then contact a supervisor of the technician. The home entry point is represented on the map by a house pin. FIG. 48 exemplarily illustrates a twenty third page of a survey form comprising drop pin path footage of plant extension pins, in accordance with one embodiment of the present invention. FIG. 49 exemplarily illustrates a twenty fourth page of a survey form comprising another drop pin path footage of plant extension pins, in accordance with one embodiment of the present invention.

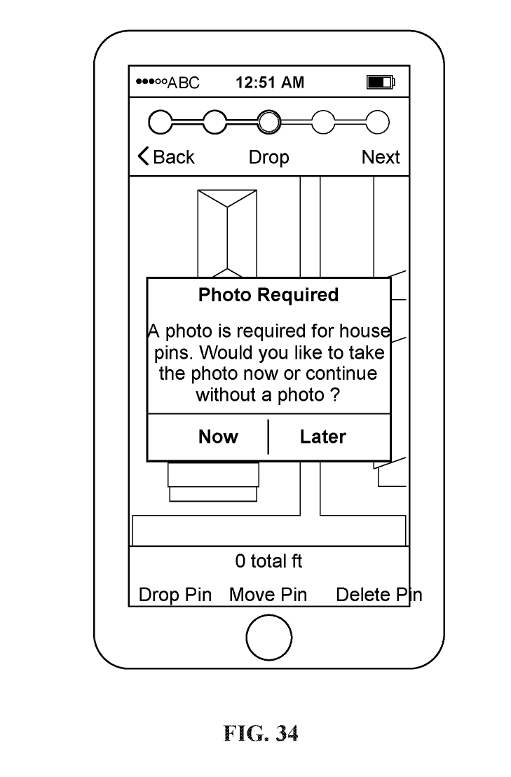

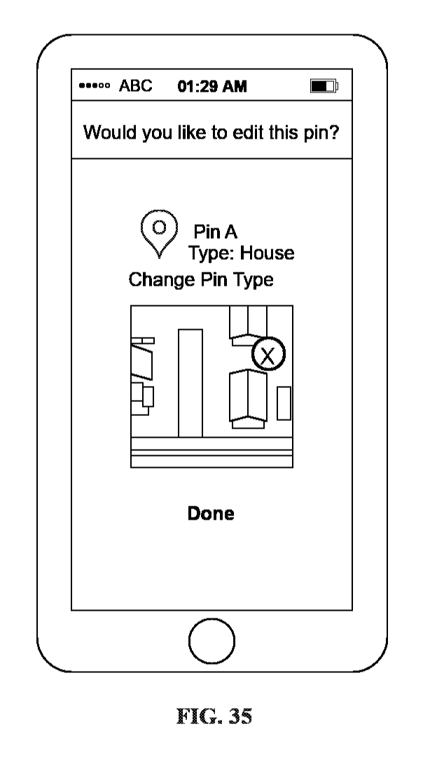

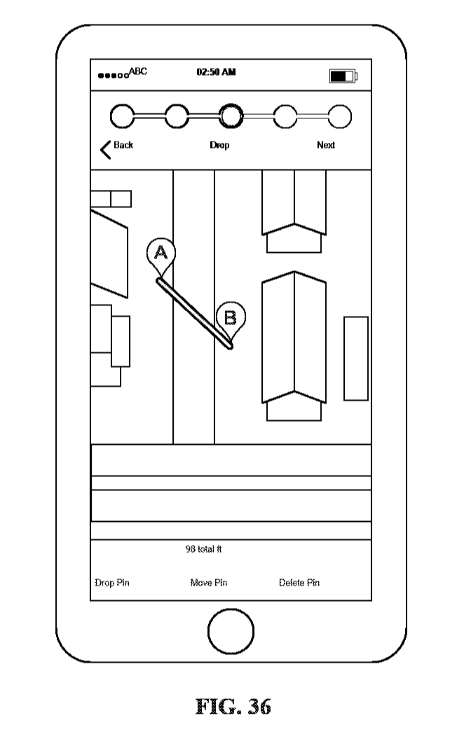

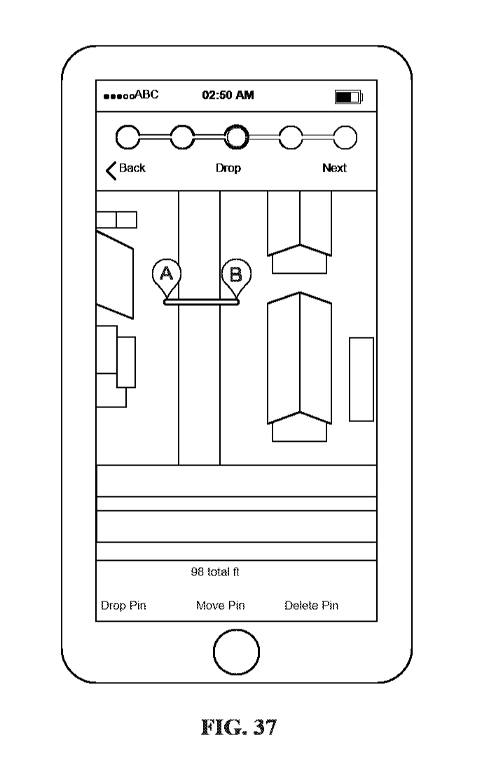

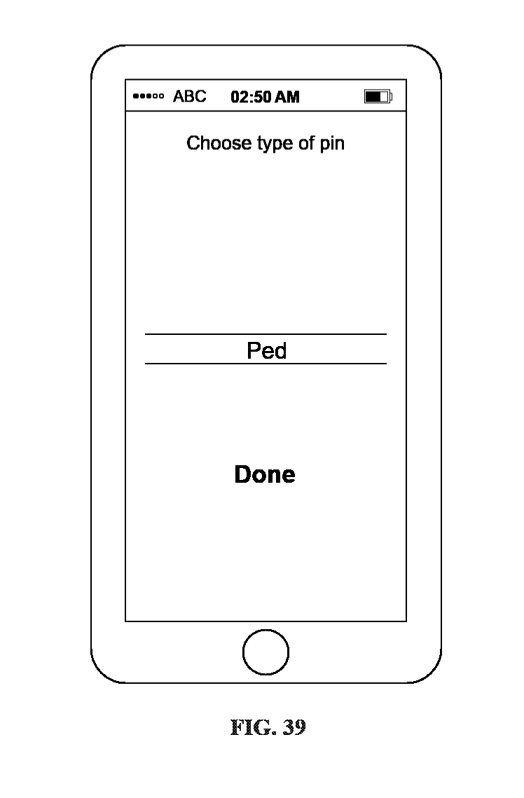

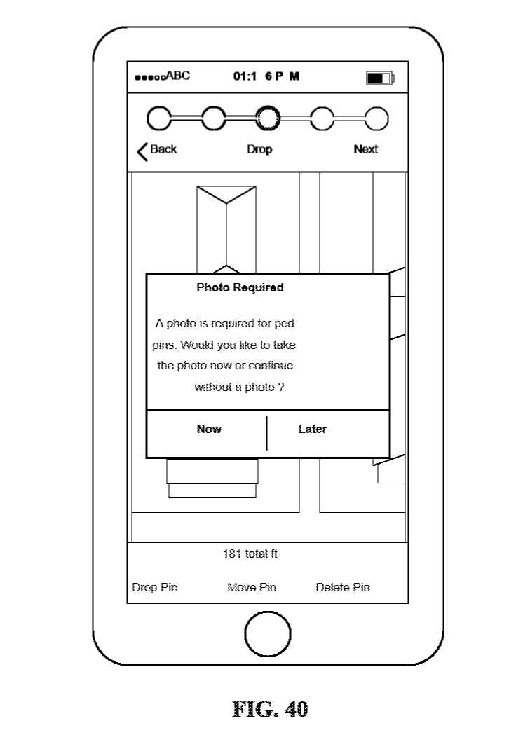

Referring FIG. 1, the task delegation module 140 instructs the technician to take a picture of the customer's home. The technician is enabled to take the picture real time or select from a gallery of pictures in a smart device. FIG. 34 exemplarily illustrates a ninth page of a survey form instructing a technician to take a picture, in accordance with one embodiment of the present invention. FIG. 35 exemplarily illustrates a tenth page of a survey form enabling a technician to assign a picture to a drop pin, in accordance with one embodiment of the present invention. After taking the picture and assigning the picture to the drop pin, the technician is enabled to continue with a survey. FIG. 36 exemplarily illustrates an eleventh page of a survey form comprising a first view of a drop pin path, in accordance with one embodiment of the present invention. FIG. 37 exemplarily illustrates a twelfth page of a survey form comprising a second view of a drop pin path, in accordance with one embodiment of the present invention. FIG. 39 exemplarily illustrates a fourteenth page of a survey form enabling a technician to choose a pin type in a drop pin path, in accordance with one embodiment of the present invention. FIG. 40 exemplarily illustrates a fifteenth page of a survey form enabling a technician to assign another picture to a drop pin in a drop pin path, in accordance with one embodiment of the present invention.

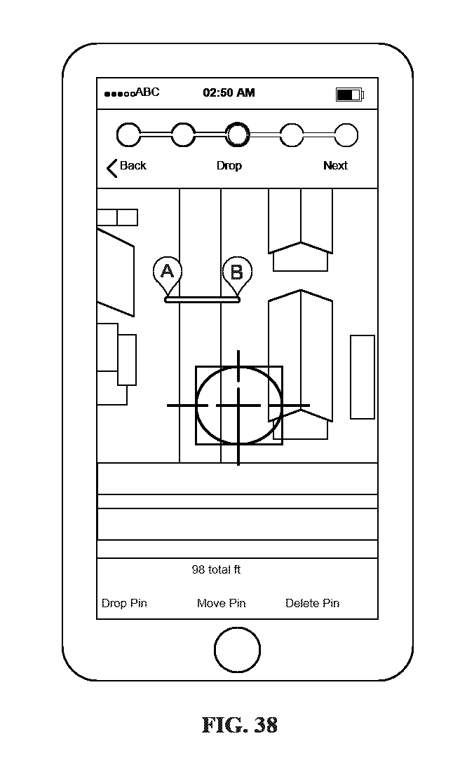

Referring FIG. 1, the task delegation module 140 uses the picture to represent the house pin on the map. The technician is enabled to move the plurality of pins around different places on the map. Further, the technician is enabled to delete at least one pin among the plurality of pins. FIG. 38 exemplarily illustrates a thirteenth page of a survey form enabling a technician to delete a pin in a drop pin path, in accordance with one embodiment of the present invention.

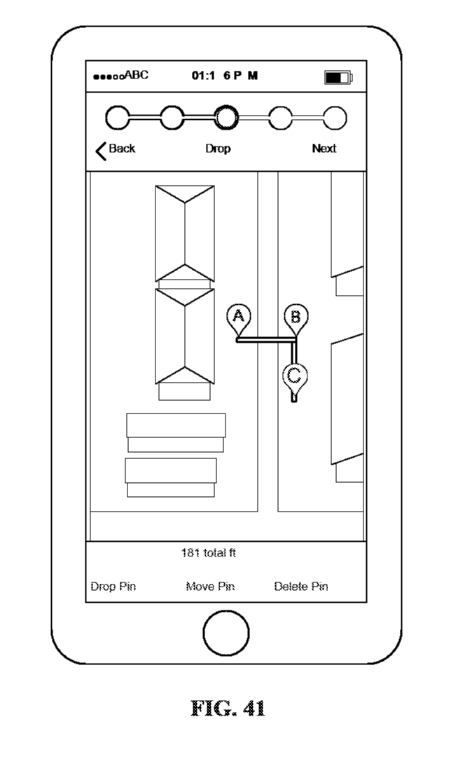

Referring to FIG. 1 again, the maximum drop footage permitted for the cable installation is 150 feet. FIG. 41 exemplarily illustrates a sixteenth page of a survey form enabling a technician to calculate footage of a drop pin path, in accordance with one embodiment of the present invention. In one example, the footage is calculated by means of global positioning system (GPS) data.

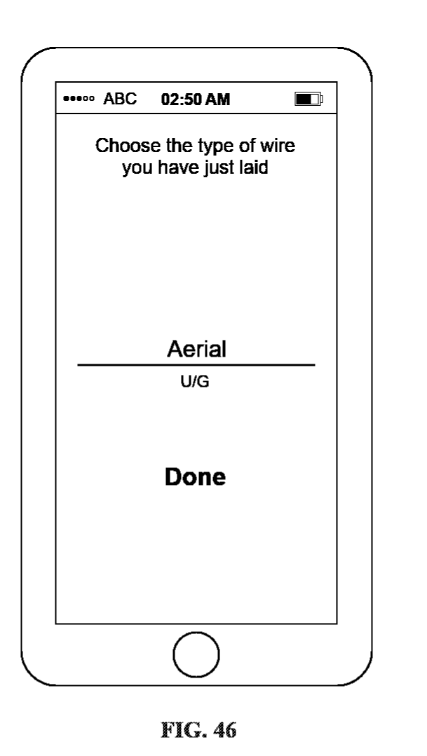

Referring FIG. 1 again, if the technician provides the task delegation module 140 a valid justification for the technician requiring the drop footage to be greater than 150 feet, then the task delegation module 140 enables the technician to extent the drop footage to 250 feet. In yet another example, the task delegation module 140 enables the technician to designate the cable installation as one of an aerial cable installation and an underground cable installation. FIG. 46 exemplarily illustrates a twenty first page of a survey form enabling technician to designate a cable installation as one of an aerial cable installation and an underground cable installation, in accordance with one embodiment of the present invention.

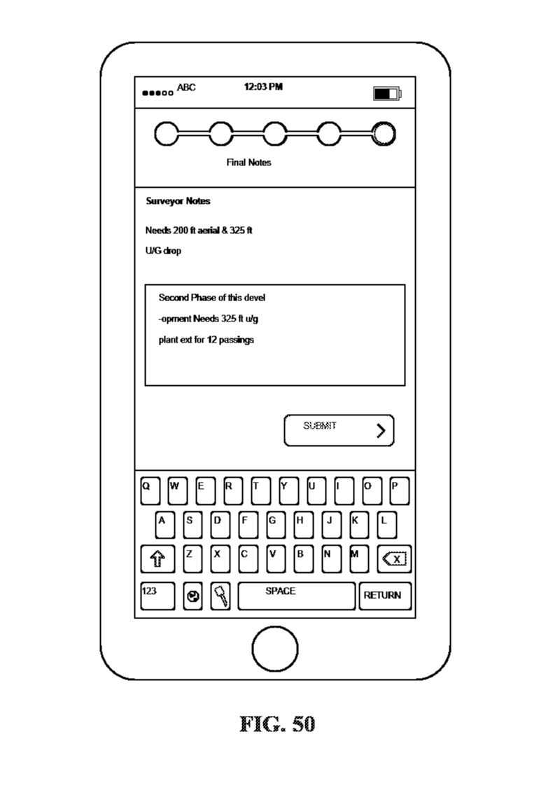

Referring FIG. 1 again, the task delegation module 140 translates information in the survey form and the information associated with the drop pin path into a written paragraph. Further, one of the technician and a surveyor is enabled to add manual notes into a plurality of comments fields in the survey form. In one example, if the drop footage exceeds 150 feet, then the technician is required to justify the drop footage by entering comments in the plurality of comment fields. FIG. 50 exemplarily illustrates a twenty fifth page of a survey form enabling a technician and a surveyor to add manual notes into a plurality of comment fields, in accordance with one embodiment of the present invention.

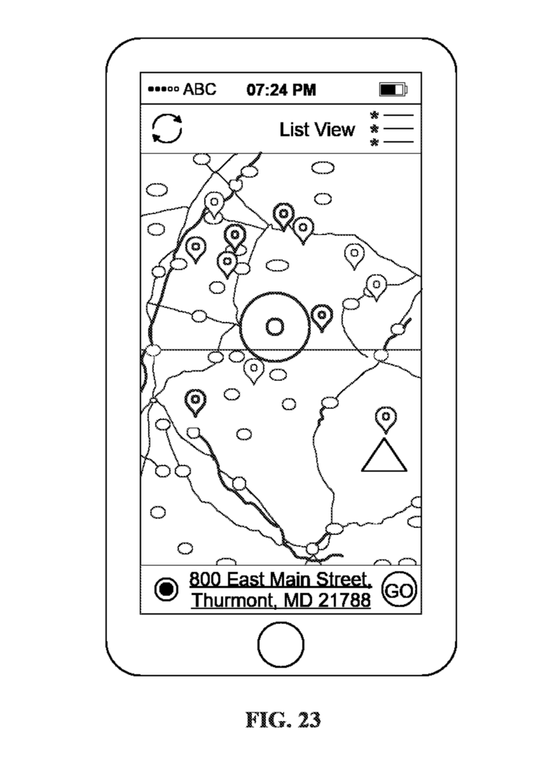

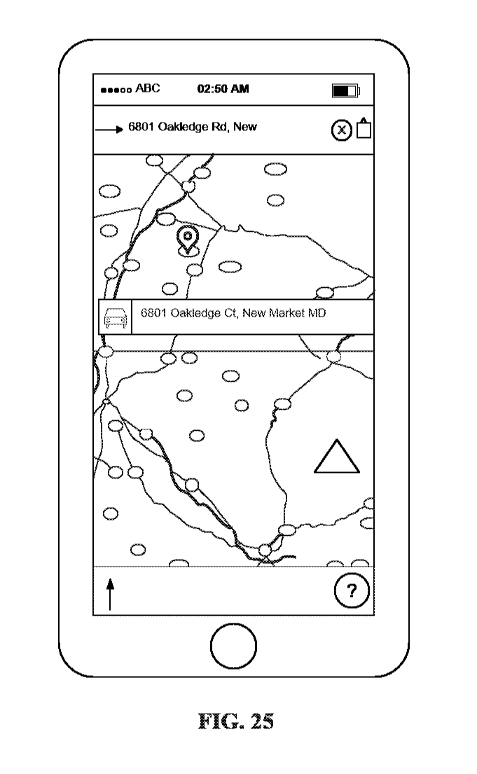

Referring to FIG. 1, the display module 145 presents the at least one technician with information associated with the at least one task and the plurality of tasks. The display module 145 presents information to the at least one technician via at least one of a Liquid Crystal Display screen (LCD), an LED screen, a speaker, a smartphone, a laptop, a personal computer, and a personal digital assistant. The display module 145 presents the information in a tabulated format. The display module 145 sorts the at least one task and the plurality of tasks based on at least one of delegation date of each of the plurality of tasks, deadlines assigned for each of the plurality of tasks, and priority levels associated with the plurality of tasks. In one example, the technician is presented with the at least one task and the plurality of tasks delegated to the technician, on a pictorial map. FIG. 23 is an exemplary screenshot of a pictorial map comprising information regarding the plurality of tasks, in accordance with one embodiment of the present invention. FIG. 25 is an exemplary screenshot of another pictorial map comprising information regarding the plurality of tasks, in accordance with one embodiment of the present invention. The technician is enabled to switch to a list view by pressing at least one graphical button in the pictorial map. In one example, the at least one graphical button reads “map view”. The technician is enabled to begin a survey from at least one of the map view and the list view.

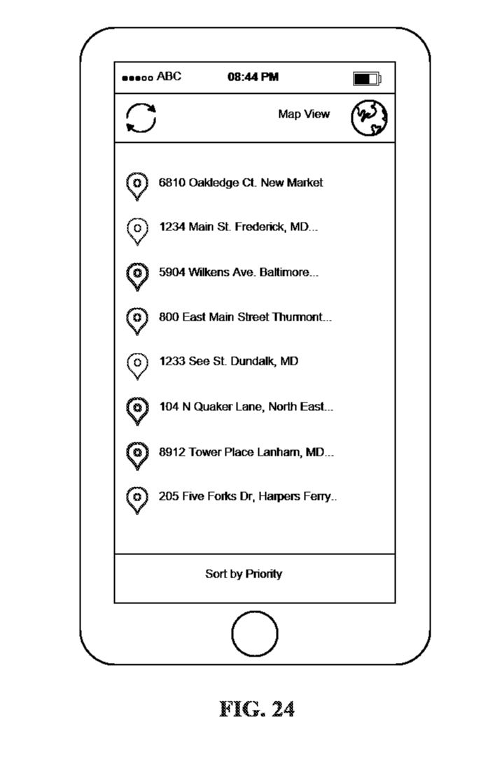

Referring to FIG. 1 again, in another example, the technician is presented with the at least one task and the plurality of tasks in a list format. FIG. 24 is an exemplary screenshot of a list comprising information regarding the plurality of tasks sorted by priority level of each of the plurality of tasks, in accordance with one embodiment of the present invention.

Referring to FIG. 1 again, in one example information regarding the plurality of tasks are sorted by distance and location. Information regarding each of the plurality of tasks and the at least one task is displayed on graphical “pins” superimposed on the pictorial map. In one exemplary illustration of the present invention, the graphical “pins” are colored based on at least one of deadlines associated with each task, delegation date of each task, priority levels of each task and distance of the technician to locations associated with each task. In one example, the graphical “pins” are colored green if deadline is within one day, colored orange is deadline is within two days, and colored red if deadline is within three days. The technician is enabled to select a plurality of subsequent tasks from the plurality of task per convenience of the technician.

The display module 145 presents the technician with a final summary of the information in the survey form. The final summary comprises data in the survey form, manually input information in the survey form, the drop pin path, combined footages of the aerial cables, the underground cables, the plant extensions, pictures submitted to the task delegation module 140, the drop footage lengths, information associated with road bores, number of drops, pedestals, bends, mid points, active plants, and list of the plurality of tasks. The technician is enabled to approve and accept the final summary. Prior to approving the final summary, the technician is enabled to edit data displayed in the final summary.

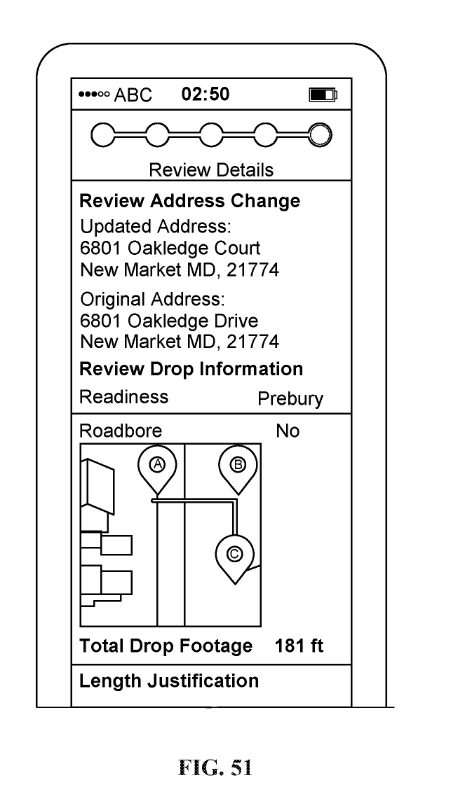

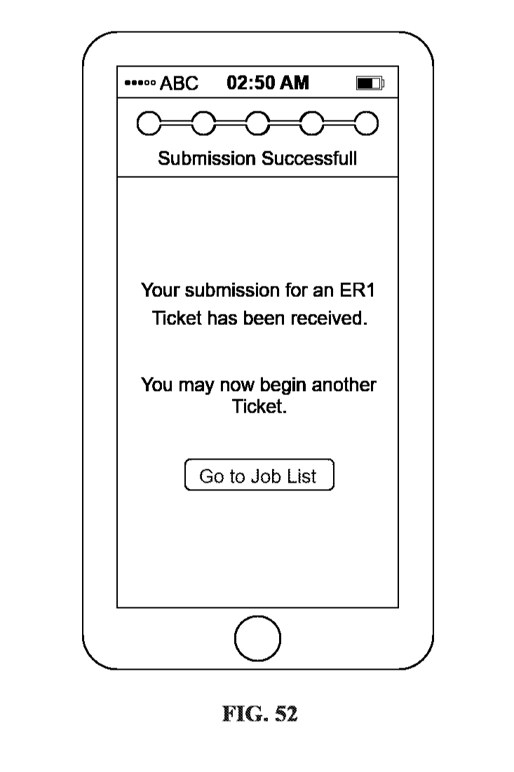

If the technician accepts the final summary, then the display module 145 sends a submission successful message to the first user terminal 105, the second user terminal 110, and the server 120. If the technician is out of range of the network 115, then the display module 145 waits for the technician to be in range with the network 115 before presenting the final summary. In one example, if the technician is out of cellular signal range, then the technician stops from translating the final summary until the technician comes within cellular range. FIG. 51 exemplarily illustrates a twenty sixth page of a survey form comprising a portion of a final summary presented to a technician, in accordance with one embodiment of the present invention. FIG. 52 exemplarily illustrates a twenty seventh page of a survey form comprising a confirmation message to a technician, in accordance with one embodiment of the present invention.

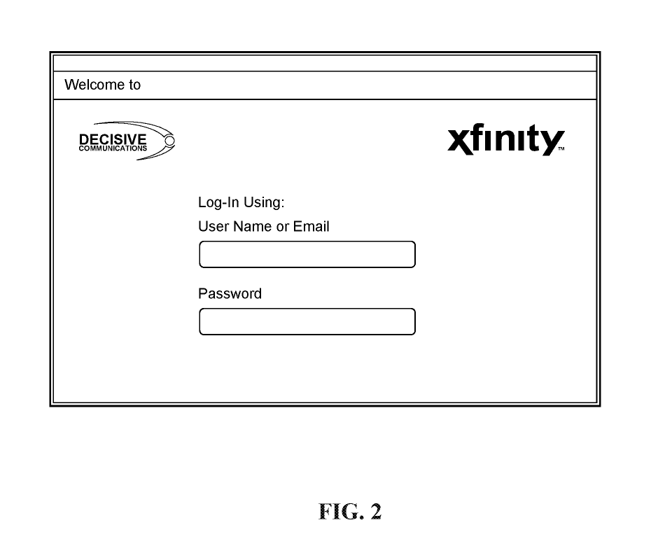

Referring FIG. 1, the input module 135 presents the technician and the customer with a log-in page. The log-in page is externally facing, and has assigned predefined permission levels for different customers and different technicians. In one example, the assigned predefined permission levels comprise business suite permission levels assigned by local administrators. FIG. 2 exemplarily illustrates a screen shot of a log-in page for the back-end aspect of the apparatus for delegating tasks, in accordance with an embodiment of the present invention. Referring to FIG. 2, the log-in page receives a username/email ID and a password as user credentials. In one example, a technician is prompted to log in again if the user credentials are altered by the technician.

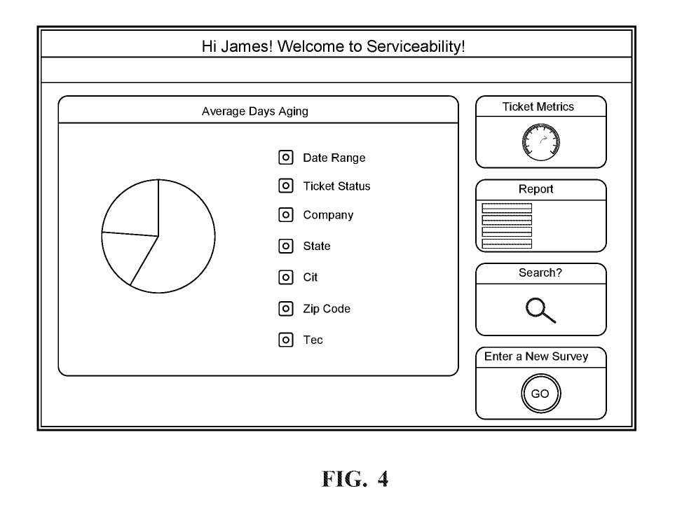

Referring to FIG. 1, the apparatus for delegating tasks has an “average days aging” feature. The average aging feature enables the technician to have information associated with the plurality of tasks displayed different viewable formats. Examples of the different viewable formats include, but is not limited to pie charts, line charts and bar graphs. FIG. 4 exemplarily illustrates a screenshot of a pie chart based representation of data associated with the “average days aging feature”, in accordance with one embodiment of the present invention.

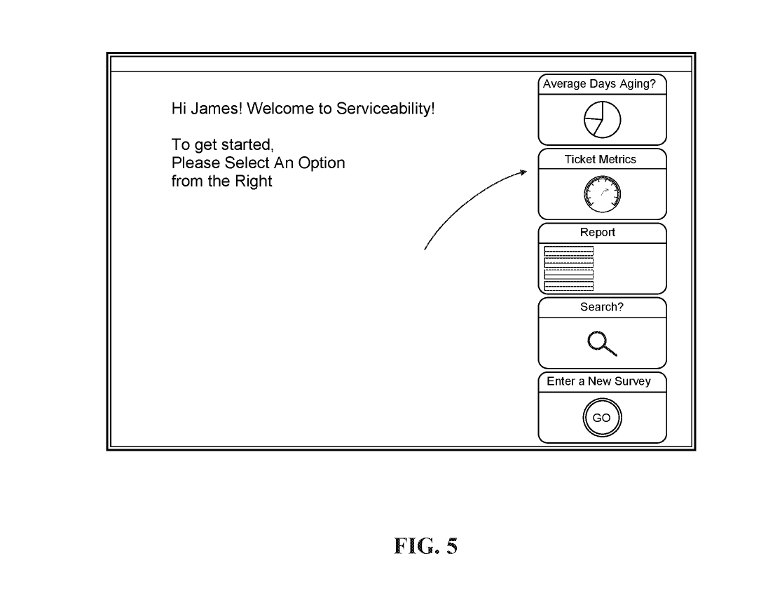

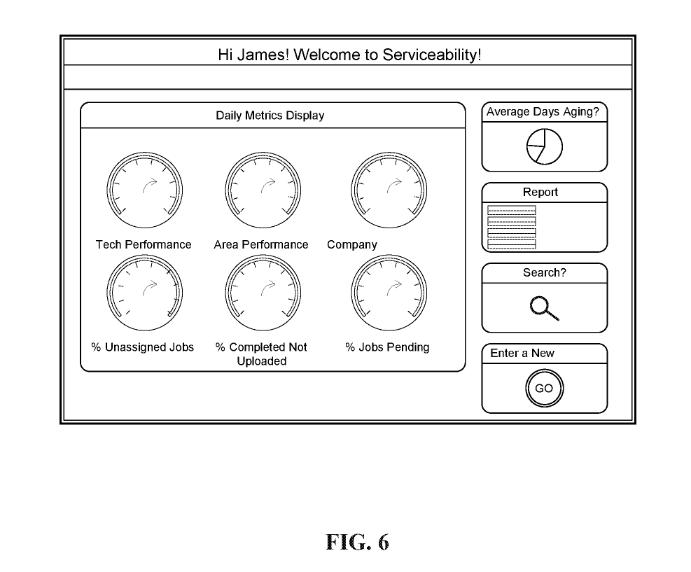

Referring FIG. 1, the task delegation module 140 enables the technician to manipulate the pie charts, line charts, and the bar graphs for data the technician wants to see displayed. In another example, the task delegation module 140 enables the technician to access a ticket metrics feature. FIG. 5 exemplarily illustrates a screen shot of a home screen comprising graphical representation of an option for a user to access the ticket metrics feature, in accordance with one embodiment of the present invention. Referring to FIG. 1 again, the ticket metrics feature comprises a plurality of gauges are utilized for easier use and understanding of the technician. The plurality of gauges enables the technician to translate uploaded information into real time data for each area's customized options. FIG. 6 exemplarily illustrates a screenshot of graphical representation of the plurality of gauges forming part of the ticket metrics feature, in accordance with one embodiment of the present invention.

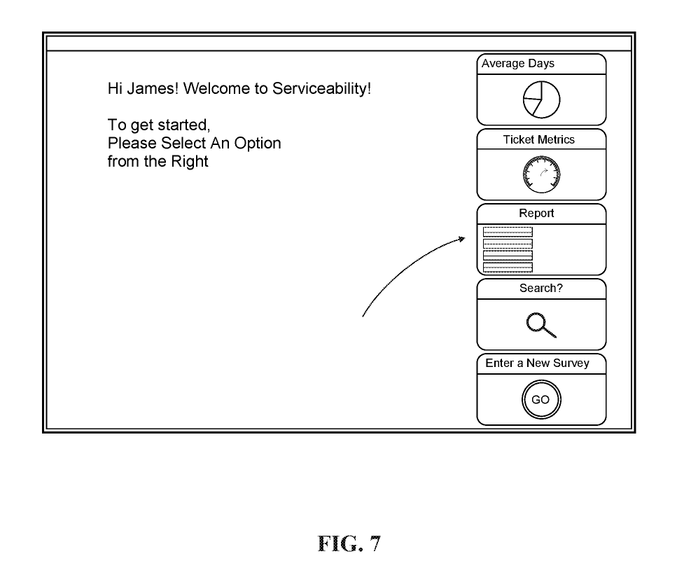

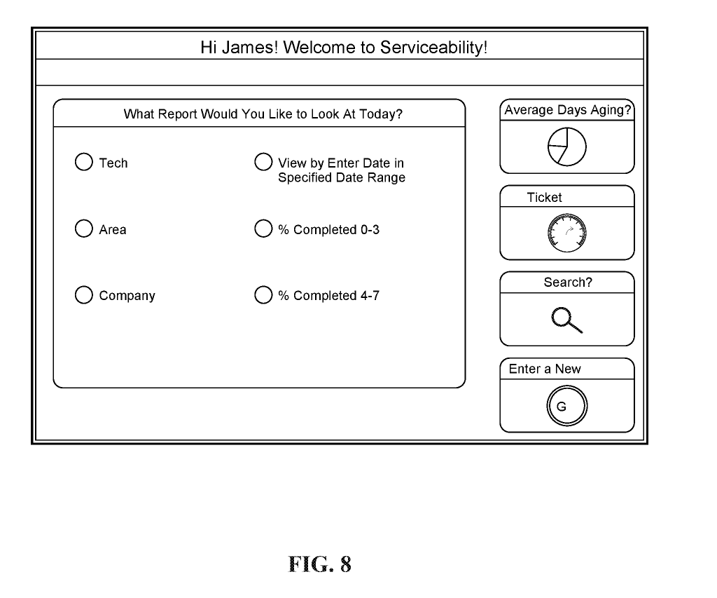

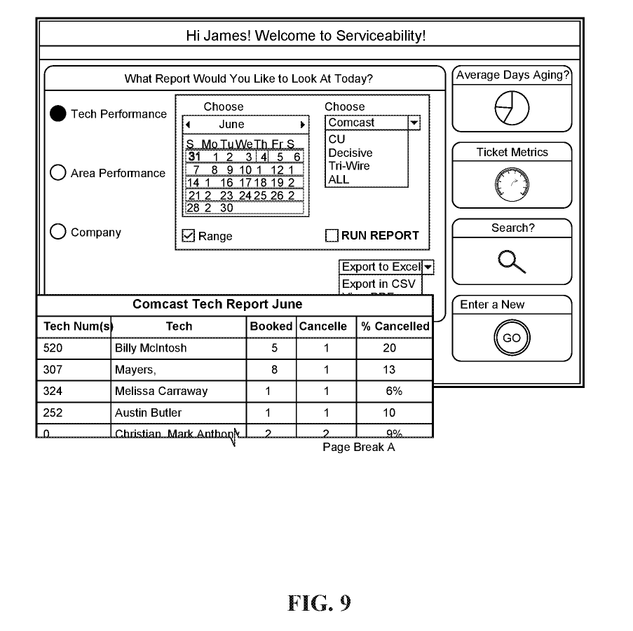

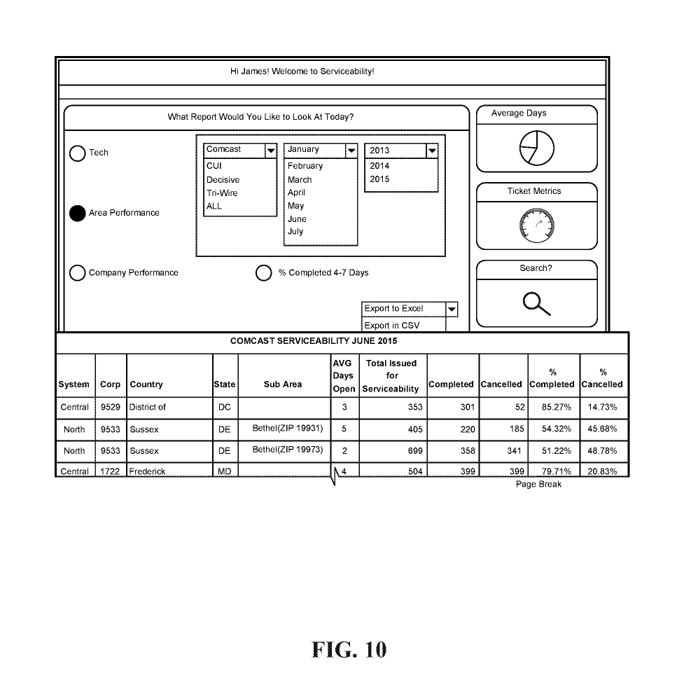

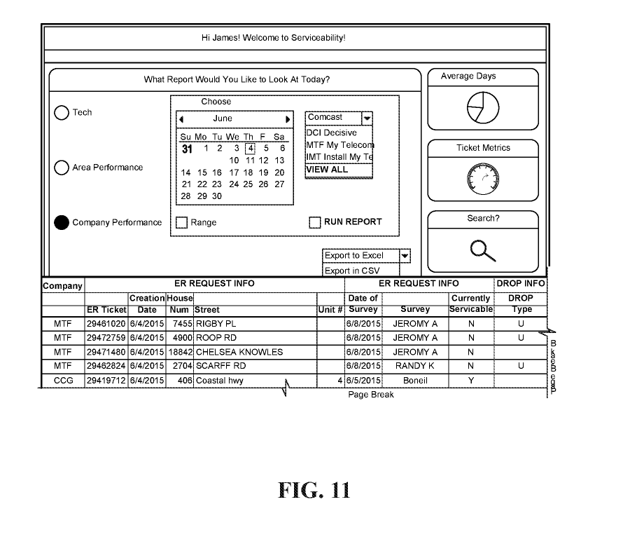

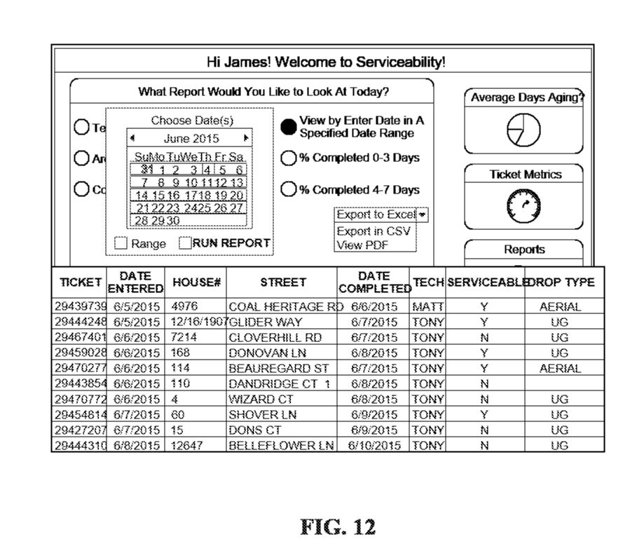

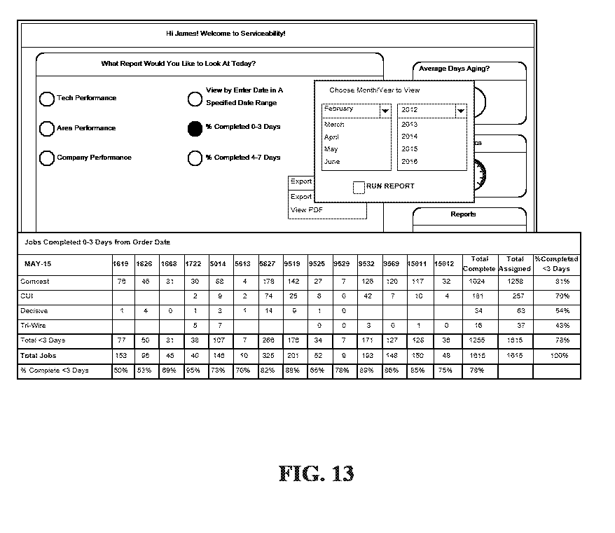

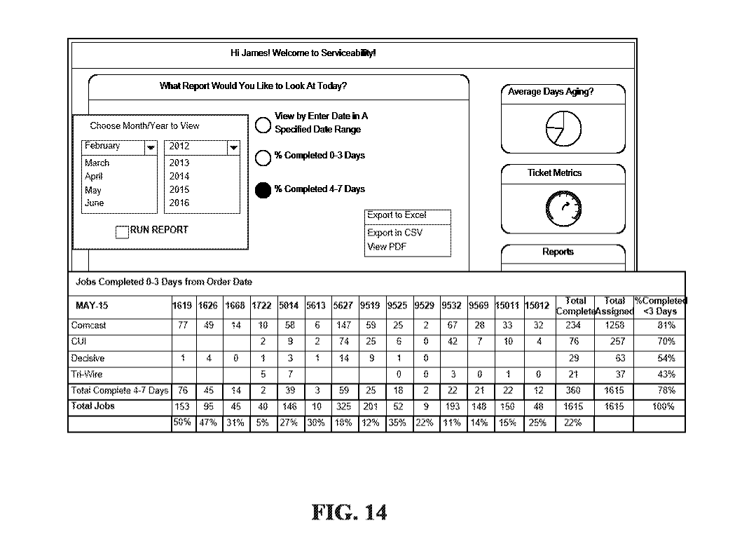

Referring to FIG. 1 again, the task delegation module 140 presents the technician with a reports feature. FIG. 7 exemplarily illustrates a screen shot of a home screen comprising graphical representation of an option for a user to access the ticket metrics feature, in accordance with one embodiment of the present invention. Referring to FIG. 1 again, the reports feature present the technician with a plurality of reports. The technician and the customer is enabled to access information in at least one report among the plurality of reports by selecting the at least one report. Further, task delegation module 140 enables the customer and the technician for customization of each report among the plurality of reports. Further, the task delegation module 140 generates a plurality of customized reports based on priority levels, date ranges, and company performance. FIG. 8 exemplarily illustrates a screenshot of a plurality of reports displayed by a task delegation module, in accordance with one embodiment of the present invention. Referring to FIG. 1 again, the plurality of reports comprises a Tech performance report capable to be used as a coaching tool. FIG. 9 exemplarily illustrates a portion of a screenshot of a tech performance report, in accordance with one embodiment of the present invention. Referring to FIG. 1, the plurality of reports comprises an area performance report. FIG. 10 exemplarily illustrates a portion of a screenshot of an area performance report, in accordance with one embodiment of the present invention. Referring to FIG. 1 again, the plurality of reports further comprises a company performance report. FIG. 11 exemplarily illustrates a portion of a screenshot of a company performance report, in accordance with one embodiment of the present invention. Referring to FIG. 1 again, the plurality of reports comprises a company performance report for a user-specified date range. FIG. 12 exemplarily illustrates a portion of a screenshot of a company performance report for a user-specified date range, in accordance with one embodiment of the present invention. Referring to FIG. 1 again, the plurality of reports comprises a tech performance report for a time interval up to three days. FIG. 13 exemplarily illustrates a portion of a screenshot of a tech performance report for a time interval up to three days, in accordance with one embodiment of the present invention. Referring to FIG. 1 again, the plurality of reports comprises a tech performance report for a time interval between four to seven days. FIG. 14 exemplarily illustrates a portion of a screenshot of a tech performance report for a time interval between four to seven days, in accordance with one embodiment of the present invention.

Referring to FIG. 1 again, the display module 145 displays the plurality of reports on at least one of an LED screen, an LCD screen, and a smartphone. Further, the task delegation module 140 can export the plurality of reports in at least one of Excel, Comma Separated Value (CSV) and PDF format. Further, the display module 145 enables a plurality of reports to run. The display module 145 displays the company performance report on at least one of an LED screen, an LCD screen, and a smartphone. Further, the company performance report is exported to at least one of an Excel, a Comma Separated Value (CSV) and a PDF format.

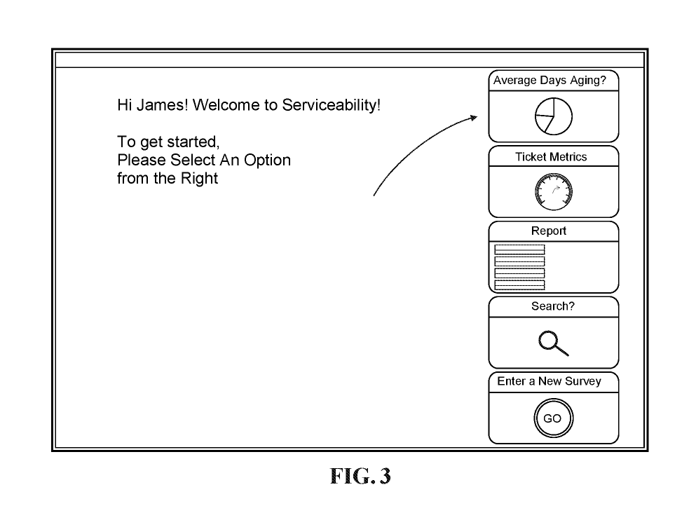

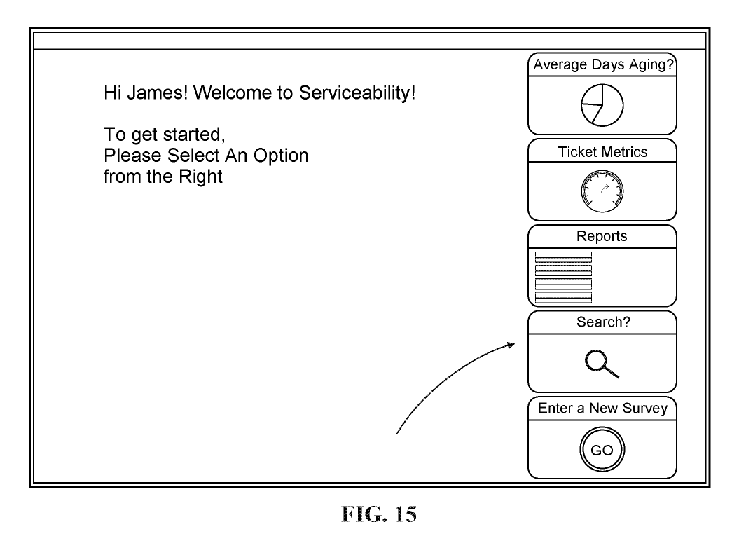

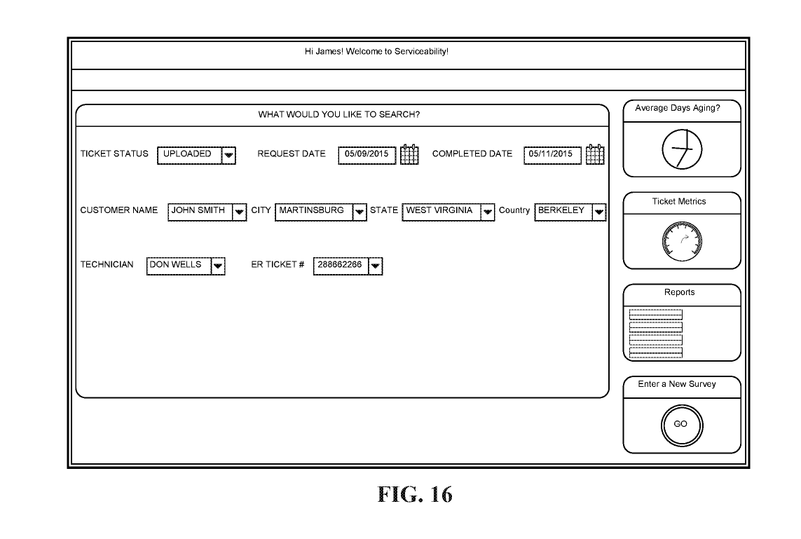

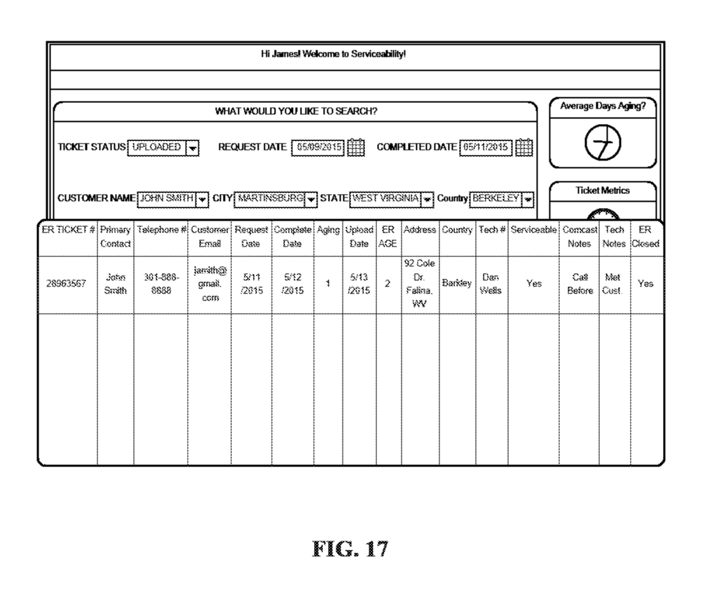

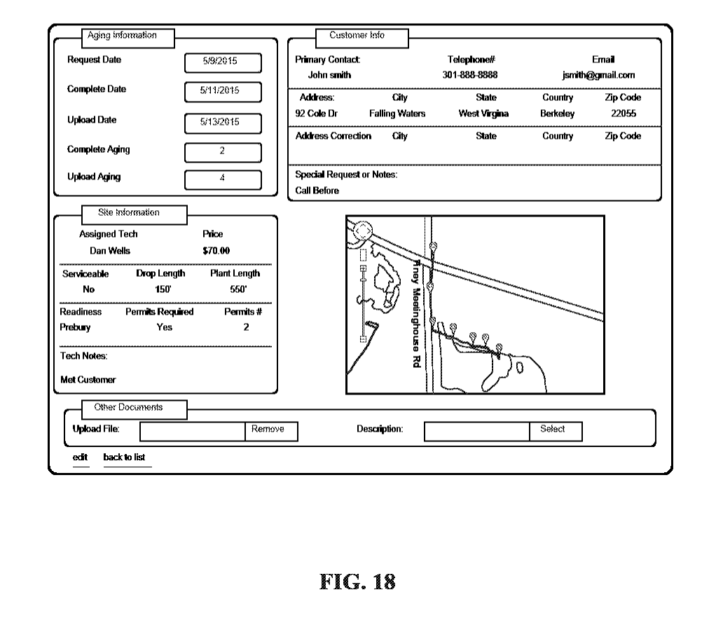

In another example, the display module 145 presents the technician and the customer with a home screen. FIG. 3 exemplarily illustrates a home screen in accordance with one embodiment of the present invention. Referring to FIG. 1, the home screen further comprises a search feature. FIG. 15 exemplarily illustrates a screenshot of a home screen comprising a “search feature”, in accordance with one embodiment of the present invention. FIG. 16 exemplarily illustrates a screenshot of a “search feature”, in accordance with one embodiment of the present invention. FIG. 17 illustrates a screen shot of a page of a completed search for the back-end aspect of the apparatus for delegating tasks, in accordance with an embodiment of the present invention. FIG. 18 exemplarily illustrates a screen shot of another page of a completed search for the back-end aspect of the apparatus for delegating tasks, in accordance with another embodiment of the present invention.

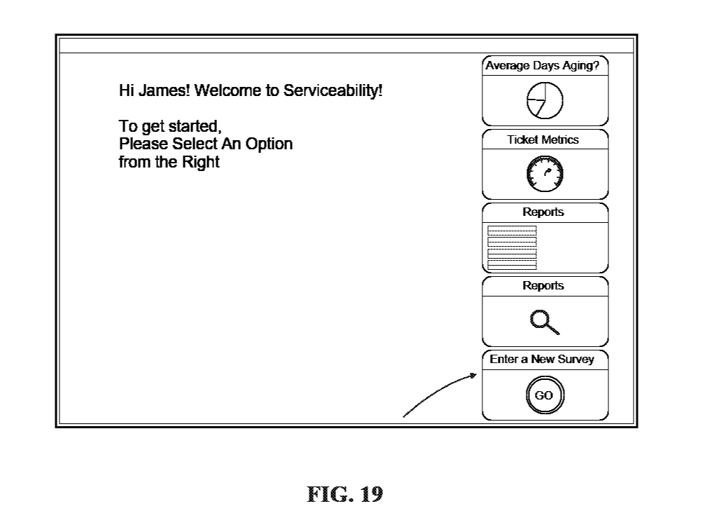

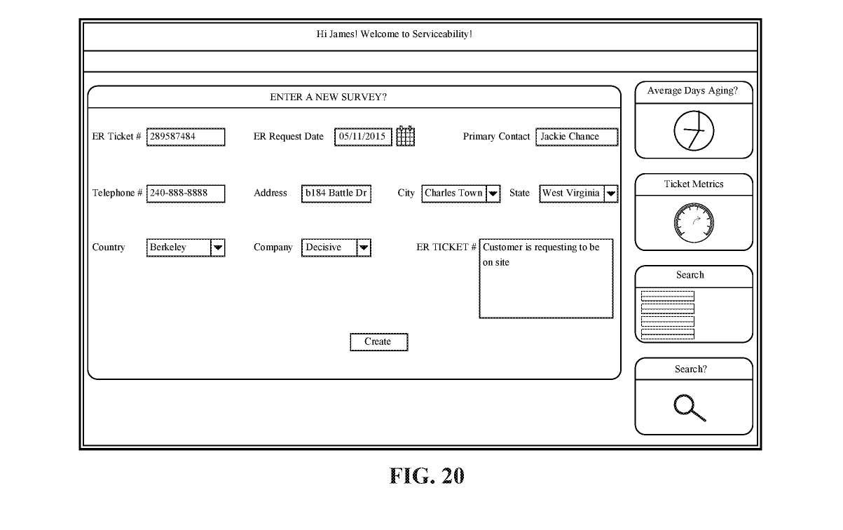

Referring to FIG. 1 again, the home screen comprises a new survey feature. FIG. 19 exemplarily illustrates a screenshot of a home screen comprising an option to enter a new survey, in accordance with one embodiment of the present invention. FIG. 20 exemplarily illustrates a screen shot of a page comprising details associated with a new survey for the back-end aspect of the apparatus for delegating tasks, in accordance with another embodiment of the present invention.

Referring FIG. 1 again, the home screen comprises a ticket status feature. The ticket status comprises information regarding the at least one task. The display module 145 presents the task as one of an assigned task, an unassigned task, a pending task, a completed task, a cancelled task, and a recently uploaded task.

In another example, the first input is stored in a ticket format, in a ticket. The ticket stores information comprised in the first input and additional information received from the technician. In one example, a plurality of service operators in vicinity of location associated with the task, receive the ticket. The plurality of service operators is enabled to assign the ticket to the technician. In one example, the ticket has option of a manual assign override. Further, the task delegation module 140 is enabled to automatically complete a plurality of fields in the ticket. Fields incapable of being filled by the task delegation module 140 are filled by the technician.

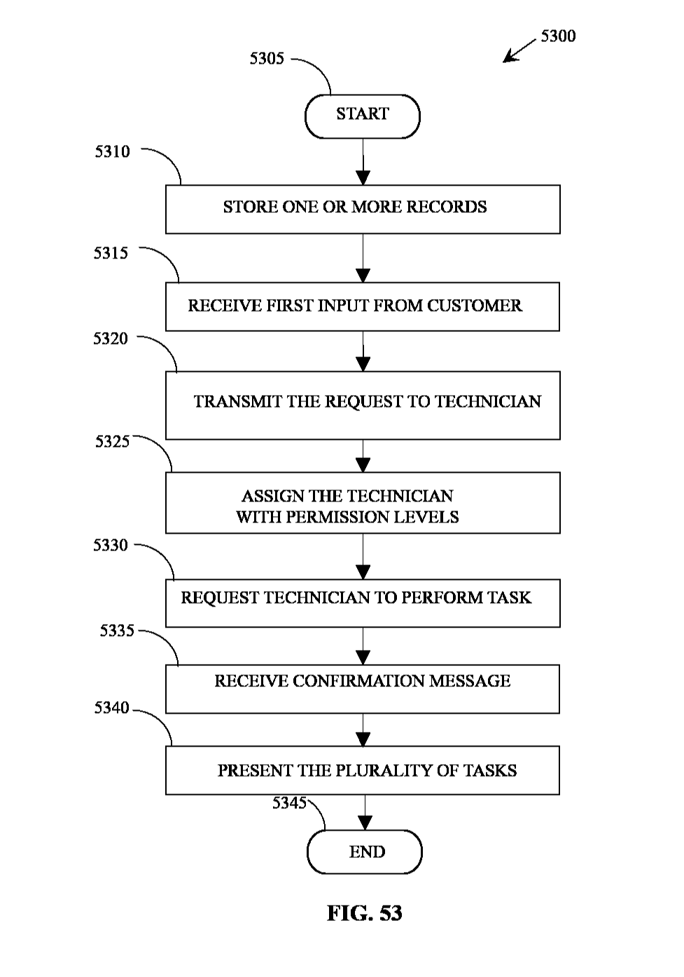

FIG. 53 is a flowchart of a method 5300 of delegating tasks to cable installation technicians according to an embodiment of the present invention. In an embodiment, the corresponding screen shots illustrated, and described above in FIGS. 2-52, are related to the method 5300 of delegating tasks to the cable installation technicians incorporated in the apparatus. The method 5300 is implemented in an environment comprising a first user terminal, a second user terminal and a server. The first user terminal, the second user terminal, and the server are connected with each other via a network. The network is at least one of a mobile network, a local area network, and a wide area network. The environment hosts an apparatus for delegating tasks comprising a memory unit, and a processor. At least one technician and At least one customer communicates with the apparatus for delegating tasks via at least one of the first user terminal and the second user terminal. The first user terminal and the second user terminal are at least one of personal computers, laptops, smartphones, and personal digital assistants. The apparatus for delegating tasks requests the technician as well as the customer to sign in into the apparatus for delegating tasks using one or more user credentials. Examples of the user credentials include, but are not limited to usernames, passwords, fingerprints, and retina scans. The method 5300 commences at step 5305.

At step 5310, the memory unit stores a database comprising one or more records associated with at least one technician, and a set of program modules. The one or more records comprise information regarding a plurality of tasks delegated to at least one technician, locations associated with each of the plurality of tasks, priority levels of each of the plurality of tasks, and permission levels associated with the at least one technician. The permission levels indicate a set of mobile applications and features accessible to the at least one technician. The permission levels are managed in the database by a local administrator. The permission levels are capable of being altered dynamically for each technician among a plurality of technicians as needed. The one or more records further comprises delegation date of each of the plurality of tasks, deadlines assigned for each of the plurality of tasks, and priority levels associated with the plurality of tasks. The processor executes the set of program modules. The set of program modules comprises an input module, a task delegation module, and a display module.

At step 5315, the processor, via the input module, receives from at least one customer, a first input. The first input comprises a request to perform at least one task, a location associated with the at least one task, a deadline associated with the at least one task, and information regarding permission levels required by the at least one technician to perform the at least one task. The input module receives the first input via at least one of a computer mouse, a touch screen, a microphone, and a camera.

At step 5320, the processor, via the task delegation module, transmits the request to perform the at least one task, the deadline associated with the at least one task, and the location associated with the at least one task, to at least one technician.

At step 5325, the processor, via the task delegation module, assign the at least one technician with permission levels required by the at least one technician to perform the at least one task.

At step 5330, the processor, via the task delegation module, requests the at least one technician to perform the at least one task.

At step 5335, the processor, via the task delegation module, receives a confirmation message from the at least one technician, to perform the at least one task. In one example, the task delegation module receives the confirmation message via the technician's entries in a survey form. The task delegation module presents the survey form to the technician and enables the technician to a plurality of different fields in the survey form. The survey form comprises a status bar comprising an indication of the technician's progress in completing the survey form. Further, the status bar comprises navigation buttons to enable the technician to navigate between different pages of the survey form. In one example, the task delegation module receives an estimation of the drop footage via the survey form. The survey form enables the technician to input the estimate of drop footage of a cable installation in the survey form. The task delegation module limits the technician from installing cable with a drop footage greater than 250 feet. In one example, if the technician inputs drop footage greater than 250 feet, the task delegation module presents the technician with the message “path too long”. In one example, if the technician refuses to perform the at least one task, then the technician is enabled to add a plant extension and the task delegation module reduces the drop footage and logic for the drop footage to a value lesser than feet. In one example, the plant extension is represented by plant extension pins on the map. Unlike other pins, the plant extension pins may be of an unlimited number. If the technician starts at one of the pedestal pin and the pole pin, then the task delegation module requires the technician to take a picture of the pedestal in order to reduce redundancies. The task delegation module delegates the plant extension pins with an orange color. In another example, the task delegation module receives a justification form the technician for refusing to perform the task. The task delegation module enables the user to input technical aspects about the cable installation such as road bore, underground cable installation, and information associated with special equipments required for the cable installation. In another example, the task delegation module instructs the technician to select a drop pin path for the cable installation. The task delegation module directs the technician to start at a home entry point and then directs the technician to draw the drop pin path from the home entry point to a pedestal box. The task delegation module has a predefined logical sequence, which identifies each pin with an icon of a house for the home pin, pedestal for the pedestal pin, and various pin bubbles for path mid-points. In a preferred embodiment, the technician will have a minimum requirement of 3 pins and a maximum requirement of 4 pins. The task delegation module presents position of a plurality of pins in the drop pin path on the map for ease of use of the technician. The plurality of pins comprises a pole, a riser pole, a pedestal, a tie down, a bend, a midpoint, and an active plant. The pole is an aerial marker where the active plant and an aerial drop meets. The riser pole signifies a directional change from aerial to underground or from underground to aerial. The task delegation module requires a photo to set up a pedestal pin. The pedestal pin is the shared location where the underground cable meets the plant extension. The bend indicates directional change in an original drop pin path. The active plant requires a photo.

Further, the apparatus for delegating tasks calculates drop footage between the pins. In a preferred embodiment, if the footage entered reaches a 300 feet maximum threshold, and the drop pin path is rejected by the task delegation module. The task delegation module displays a rejection message, such as “Upload Failed—Error—Path Length exceeds Maximum Threshold”. Further, the technician is prompted to confirm locations of the plurality of pins and then contact a supervisor of the technician. The home entry point is represented on the map by a house pin. The task delegation module instructs the technician to take a picture of the customer's home. Moreover, the task delegation module uses the picture to represent the house pin on the map. The technician is enabled to move the plurality of pins around different places on the map. Further, the technician is enabled to delete at least one pin among the plurality of pins. In another example, the maximum drop footage permitted for the cable installation is 150 feet. However, if the technician provides the task delegation module a valid justification for the technician requiring the drop footage to be greater than 150 feet, then the task delegation module enables the technician to extent the drop footage to 250 feet. In yet another example, the task delegation module enables the technician to designate the cable installation as one of an aerial cable installation and an underground cable installation.

The task delegation module translates information in the survey form and the information associated with the drop pin path into a written paragraph. Further, one of the technician and a surveyor is enabled to add manual notes into a plurality of comments fields in the survey form.

At step 5340, the processor, via the display module presents the at least one technician with information associated with the at least one task and the plurality of tasks. The display module presents information to the at least one technician via at least one of a Liquid Crystal Display screen (LCD), an LED screen, a speaker, a smartphone, a laptop, a personal computer, and a personal digital assistant. The display module presents the information in a tabulated format. The display module sorts the at least one task and the plurality of tasks based on at least one of delegation date of each of the plurality of tasks, deadlines assigned for each of the plurality of tasks, and priority levels associated with the plurality of tasks. In one example, the technician is presented with the at least one task and the plurality of tasks delegated to the technician, on a pictorial map. In one example, information regarding each of the plurality of tasks and the at least one task are displayed on graphical “pins” superimposed on the pictorial map. In one exemplary illustration of the present invention, the graphical “pins” are colored based on at least one of deadlines associated with each task, delegation date of each task (aging view), priority levels of each task and distance of the technician to locations associated with each task. The display module presents the technician with a final summary of the information in the survey form. The final summary comprises data in the survey form, manually input information in the survey form, the drop pin path, combined footages of the aerial cables, the underground cables, the plant extensions, pictures submitted to the task delegation module, the drop footage lengths, information associated with road bores, number of drops, pedestals, bends, mid points, active plants, and list of the plurality of tasks. The technician is enabled to approve and accept the final summary. If the technician accepts the final summary, then the display module sends a submission successful message to the first user terminal, the second user terminal, and the server. If the technician is out of range of the network, then the display module waits for the technician to be in range with the network before presenting the final summary.

The method 5300 ends at step 5345.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. An apparatus for delegating one or more tasks for cable line installation technicians, the apparatus comprising:
a memory unit to store:
a database comprising one or more records associated with at least one technician, and
a set of program modules,
wherein the one or more records comprise information regarding a plurality of tasks delegated to the at least one technician, locations associated with each of the plurality of tasks, and permission levels associated with the at least one technician;
a processor to execute the set of program modules, wherein the set of program modules comprises:
an input module, executed by the processor, configured to receive from at least one customer, a first input, wherein the first input comprises a request to perform at least one task, a location associated with the at least one task, a deadline associated with the at least one task, and information regarding permission levels required by the at least one technician to perform the at least one task;
a task delegation module, executed by the processor, configured to
transmit the request to perform the at least one task, the deadline associated with the at least one task, and the location associated with the at least one task, to at least one technician,
assign the at least one technician with permission levels required by the at least one technician to perform the at least one task,
request the at least one technician to perform the at least one task, and
receive a confirmation message from the at least one technician, to perform the at least one task; and
a display module, executed by the processor, to present the at least one technician with the at least one task and the plurality of tasks delegated to the at least one technician.

2. The apparatus of claim 1, wherein the input module receives the first input via at least one of a computer mouse, a touch screen, a microphone, and a camera.

3. The apparatus of claim 1, wherein the display module presents information to the at least one technician via at least one of a Liquid Crystal Display screen (LCD), an LED screen, a speaker, a smartphone, a laptop, a personal computer, and a personal digital assistant.

4. The apparatus of claim 3, wherein the at least one technician and the at least one customer communicates with the apparatus for delegating tasks via at least one user terminal device.

5. The apparatus of claim 4, wherein the user terminal device is at least one of a personal computer, a laptop, a smartphone, and a personal digital assistant.

6. The apparatus of claim 1, wherein the one or more records further comprises delegation date of each of the plurality of tasks, deadlines assigned for each of the plurality of tasks, and priority levels associated with the plurality of tasks.

7. The apparatus of claim 6, wherein the display module presents the at least one task and the plurality of tasks in a tabulated format.

8. The system of claim 7, wherein the display module sorts the at least one task and the plurality of tasks based on at least one of delegation date of each of the plurality of tasks, deadlines assigned for each of the plurality of tasks, and priority levels associated with the plurality of tasks.

9. A computer implemented method of delegating tasks to cable line installation technicians, the method comprising:
storing in a memory unit, a database comprising one or more records associated with at least one technician, and a set of program modules, wherein the one or more records comprise information regarding a plurality of tasks delegated to the at least one technician, locations associated with each of the plurality of tasks, and permission levels associated with the at least one technician;
receiving by a processor via an input module, a first input, wherein the first input comprises a request to perform at least one task, a location associated with the at least one task, a deadline associated with the at least one task, and information regarding permission levels required by the at least one technician to perform the at least one task;
transmitting by the processor, via a task delegation module, the request to perform the at least one task, the deadline associated with the at least one task, and the location associated with the at least one task, to the at least one technician;
assigning by the processor, via the task delegation module the at least one technician with permission levels required by the at least one technician to perform the at least one task;
requesting by the processor, via the task delegation module, the at least one technician to perform the at least one task;
receiving by the processor via the task delegation module, a confirmation message from the at least one technician, to perform the at least one task; and
presenting by the processor via a display module, the at least one technician with the at least one task and the plurality of tasks delegated to the at least one technician.

10. The method of claim 9, wherein the input module receives the first input via at least one of a computer mouse, a touch screen, a microphone, and a camera.

11. The method of claim 9, wherein the display module presents information to the at least one technician via at least one of a Liquid Crystal Display screen (LCD), an LED screen, a speaker, a smartphone, a laptop, a personal computer, and a personal digital assistant.

12. The method of claim 11, wherein the at least one technician and the at least one customer communicates with the task delegation module and the input module via at least one user terminal device.

13. The method of claim 12, wherein the user terminal device is at least one of a personal computer, a laptop, a smartphone, and a personal digital assistant.

14. The method of claim 9, wherein the one or more records further comprises delegation date of each of the plurality of tasks, deadlines assigned for each of the plurality of tasks, and priority levels associated with the plurality of tasks.

15. The method of claim 14, wherein the display module presents the at least one task and the plurality of tasks in a tabulated format.

16. The method of claim 14, wherein the display module sorts the at least one task and the plurality of tasks based on at least one of delegation date of each of the plurality of tasks, deadlines assigned for each of the plurality of tasks, and priority levels associated with the plurality of tasks.
